(19) United States
(12) Patent Application Publication
(10) Pub. No.: US 2016/0232006 A1
(43) Pub. Date: Aug. 11, 2016

(54) FAN OUT OF RESULT OF EXPLICIT DATA GRAPH EXECUTION INSTRUCTION

(71) Applicant: QUALCOMM Incorporated, San Diego, CA (US)

(72) Inventor: Gregory Michael WRIGHT, Chapel Hill, NC (US)

(21) Appl. No.: 14/617,910

(22) Filed: Feb. 9, 2015

(51) Int. Cl. G06F 9/30

(52) U.S. Cl. CPC G06F 9/30181; G06F 9/30145

(57) ABSTRACT

An apparatus for fan out of a result of a first instruction can include first through fourth sets of memory cells and circuitry. The first set can be configured to store the result of the first instruction. The second set can be configured to store an operation code of a second instruction. The third set can be configured to store information of the second instruction. The fourth set can be configured to store an operand for the second instruction. The circuitry can be configured to connect the fourth set to an execution unit and to cause, in response to a presence of the information in the third set, the execution unit to be configured to receive a content of the first set as the operand for the second instruction. A format of the second instruction can include a sets of bits designated for the operation code and for the information.

### INTRODUCTION

1. Field

Aspects disclosed herein relate generally to fan out of a result of an in instruction, and particularly to fan out of a result of an instruction of an Explicit Data Graph Execution (EDGE) instruction set architecture.

2. Description of the Related Art

A computer program represents an algorithm as a sequence of instructions. The order of the sequence is referred to as the program order. Typically, instructions in a computer program represented in a source code, understandable to a programmer, are recast by a compiler into a machine code executable by a processing unit. As consumers have provided a market for an ever increasing number of application programs, the electronics industry has sought to increase the speed of processing units.

The ability to execute multiple instructions concurrently (i.e., parallel processing) is one method to increase the speed of processing units. In parallel processing, the processing unit includes a plurality of execution units. In one approach, an instruction is executed by an execution unit in response to all of the operands needed by the instruction having been received by the execution unit. Because it is possible, using this approach, that a first instruction is executed by a first execution unit before a second instruction is executed by a second execution unit, even though the first instruction is positioned later in the program order than the second instruction, such a processing unit can be referred to as an out-of-order (OOO) processing unit.

However, because a computer program typically includes a situation in which a result of a first instruction (i.e., a producing instruction) is an operand for a second instruction (i.e., a consuming instruction), implementations of an OOO processing unit need to consider the situation in which an operand of the consuming instruction is dependent upon the producing instruction. A delay (i.e., latency) that occurs when the consuming instruction is waiting for the producing instruction to make its result available to the consuming instruction can undermine the advantage of parallel processing.

One tactic to address the problem of latency is to have the producing instruction configured to include an identity of a destination of a result of the producing instruction and to have the microarchitecture configured so that an identity of a location of a record, in an array of reservation stations, for an operand for the consuming instruction can be the identity of the destination of the result of the producing instruction. In this manner, the execution unit for the consuming instruction can directly receive, as an operand, the result of the producing instruction in response to the execution unit for the producing instruction producing the result of the producing instruction. An Explicit Data Graph Execution (EDGE) instruction set architecture is a set of machine code instructions designed to implement this method of parallel processing.

### SUMMARY

An exemplary aspect can be directed to an apparatus for fan out of a result of a first instruction. The apparatus can include memory cells and a circuitry. The memory cells can include a first set, a second set, a third set, and a fourth set. The first set can be configured to store the result of the first instruction. The second set can be configured to store an operation code (i.e., an opcode) of a second instruction. The third set can be configured to store an information of the second instruction. The fourth set can be configured to store an operand for the second instruction. The circuitry can be configured to connect the fourth set to an execution unit and configured to cause, in response to a presence of the information in the third set, the execution unit to be configured to receive a content of the first set as the operand for the second instruction. The first set, the second set, the third set, and the fourth set can be disjoint. A format of the second instruction can include a set of bits designated for the operation code and a set of bits designated for the information.

Another exemplary aspect can be directed to another apparatus for fan out of a result of a first instruction. The other apparatus can include means for storing the result of the first instruction, means for storing an operation code of a second instruction, means for storing an information of the second instruction, means for storing an operand for the second instruction, and means for causing, in response to a presence of the information in the means for storing the information, means for executing the second instruction to be configured to receive a content of the means for storing the result as the operand for the second instruction. The means for storing the results, the means for storing the operation code, the means for storing the information, and the means for storing the operand can be disjoint. A format of the second instruction can include a set of bits designated for the operation code and a set of bits designated for the information.

Yet another exemplary aspect can be directed to a method for fan out of a result of a first instruction. The result of the first instruction can be stored in a first set of memory cells. An operation code of a second instruction can be stored in a second set of memory cells. An information of the second instruction can be stored in a third set of memory cells. A fourth set of memory cells can be provided. The fourth set of memory cells can be configured to store an operand for the second instruction. An execution unit can be caused, in response to a presence of the information in the third set, to be configured to receive a content of the first set as the operand for the second instruction. The first set of memory cells, the second set of memory cells, the third set of memory cells, and the fourth set of memory cells can be disjoint. A format of the second instruction can include a set of bits designated for the operation code and a set of bits designated for the information.

Still another exemplary aspect can be directed to a computer processor core. The computer processor core can include an array and a circuitry. The array can have a reservation station. The reservation station can have a record. The record can have a first set of memory cells and a second set of memory cells. The first set of memory cells can be configured to store an operation code of an instruction. The second set of memory cells can be configured to store an information of the instruction. The second set of memory cells and the first set of memory cells can be disjoint. A format of the instruction can include a set of bits designated for the operation code and a set of bits designated for the information. The instruction can be of a block of instructions. The block of instructions can be configured according to a block-based instruction set architecture. The circuitry can be configured to make a determination of a presence of the information in the second set of memory cells. The circuitry can be configured to select, in response to the determination, a source of an operand for the instruction. The circuitry can be configured to execute the block of instructions as a unit.

### BRIEF DESCRIPTION OF THE DRAWINGS

These and other sample aspects are described in the detailed description, the appended claims, and the accompanying drawings.

FIG. 1 is a block diagram illustrating an example of a system in which a block-based computer processing unit can operate.

FIG. 2 is a block diagram illustrating an example of a block-based computer processor core.

FIG. 3 is a block diagram illustrating an example of an apparatus for fan out of a result of an instruction.

FIG. 4 is a block diagram illustrating an example of an environment of the apparatus illustrated in FIG. 3.

FIGS. 5 through 16 are block diagrams illustrating examples of variations of the apparatus illustrated in FIG. 3.

FIGS. 17 and 18 are diagrams illustrating examples of formats of instructions that can be executed by the apparatus illustrated in FIGS. 3 through 16.

FIGS. 19 through 23 are diagrams illustrating the states of some memory cells and switches associated with an example scenario to describe an operation of a system that includes the aspect of the apparatus illustrated in FIG. 16.

FIG. 24 is a flow diagram illustrating an example of a method for fan out of a result of an instruction.

In accordance with common practice, various features illustrated in the drawings may not be drawn to scale. Accordingly, dimensions of the various features may be arbitrarily expanded or reduced for clarity. In addition, implementations illustrated in the drawings may be simplified for clarity. Thus, the drawings may not illustrate all of the components of a given apparatus or device. Finally, like reference numerals may be used throughout the specification and the drawings to denote like features.

### DETAILED DESCRIPTION

Aspects disclosed herein relate generally to fan out of a result of an in instruction, and particularly to fan out of a result of an instruction of an Explicit Data Graph Execution (EDGE) instruction set architecture.

In an EDGE instruction set architecture, the instructions in the computer program can be assigned to groups, which can also be referred to as blocks. An EDGE instruction set architecture can be configured to operate with an out-of-order (OOO) computer processing unit configured according to a block-based microarchitecture. In a block-based microarchitecture, a computer processor core of the computer processing unit can be configured to execute a block of instructions as a unit. An EDGE instruction set architecture can be an example of a block-based instruction set architecture.

The block-based computer processor core can include a plurality of execution units. An instruction of the block of instructions can be executed by an execution unit in response to all of the operands needed by the instruction having been received by the execution unit. It is possible that a first instruction can be executed by a first execution unit before a second instruction can be executed by a second execution unit, even though the first instruction is positioned later in the program order than the second instruction.

However, in general, the block-based computer processing unit can be configured so that, if a first block of instructions is positioned earlier in the program order than a second block of instructions, instructions of the first block of instructions commence being executed before instructions of the second block of instructions commence being executed.

The number of instructions in a block of instructions can be within a range, inclusively, from one to a maximum number. The maximum number can be defined with respect to the microarchitecture of the computer processor core. For example, the maximum number can be equal to a number of reservation stations in an array of reservation stations of a computer processor core. By way of example, and not by way of limitation, if an array of reservation stations of the computer processor core has 32 reservation stations, then the number of instructions in the block of instructions can be limited to a maximum number of 32.

In general, the compiler can be configured to assign instructions to blocks of instructions according to the program order of the instructions. However, the compiler can also be configured to identify or to predict dependencies among instructions and preferably to assign instructions to the blocks of instructions so that dependent instructions are assigned to the same block of instructions.

The block of instructions can include a block header. The block header can be used at least to identify instructions of one block of instructions and to distinguish this block of instructions from other blocks of instructions. In an aspect, the block header can include information to identify a number of instructions in the block of instructions.

Often, the computer program can include a sequence of instructions in the source code in which a first instruction (i.e., a causal instruction) is configured to determine a validity of a condition and a second instruction(s) (i.e., an effectual instruction(s)) is (are) configured to be executed based upon a result of the causal instruction (e.g., a branching instruction (e.g., If X is true, Then Y)). Furthermore, sometimes there can be two sets of effectual instructions configured so that a first set of an effectual instruction(s) (i.e., a valid condition instruction(s)) is (are) configured to be executed if the result of the causal instruction indicates that the condition is valid and a second set of an effectual instruction(s) (i.e., an invalid condition instruction(s)) is (are) configured to be executed if the result of the causal instruction indicates that the condition is not valid (e.g., If X is true, Then Y, Else Z).

However, in a block-based computer processor core it can be possible that at least one effectual instruction is executed before the causal instruction is executed (i.e., before the validity of the condition has been determined).

Because both the causal instruction and the effectual instruction(s) can be assigned to the same block of instructions, the block-based computer processor core can be configured so that results of instructions of a given block of instructions are speculative results until the block-based computer processor core determines which of the speculative results are authentic results. Speculative results can be stored in a buffer memory. The process of having the block-based computer processor core determine which of the speculative results of a given block of instructions are the authentic results can be referred to as having the block of instructions commit to the authentic results.

For example, if at least one of the valid condition instruction(s), the invalid condition instruction(s), or both is executed before the causal instruction is executed (i.e., before the validity of the condition has been determined), the speculative results of these effectual instructions can be stored in the buffer memory. After the causal instruction executes to determine the validity of the condition, the block-based computer processor core can determine which of the speculative results are the authentic results. For example, if the result of the causal instruction indicates that the condition is valid, then the block-based computer processor core can commit to the result(s) of the valid condition instruction(s); if the result of the causal instruction indicates that the condition is not valid, then the block-based computer processor core can commit to the result(s) of the invalid condition instruction(s).

In an aspect, the block-based computer processor core can be configured to have a block of instructions commit in response to execution of instructions, of the block of instructions, being in a particular state. In an aspect, a block of instructions can commit in response to completion of at least one of: (1) instructions, of the block of instructions, that write information to an architectural register, (2) instructions, of the block of instructions, that store information in a memory, or (3) an instruction, of the block of instructions, that branches to another block of instructions. In an aspect, the block header can include information to identify which of the architectural registers is an object of a write instruction of the block of instructions. In an aspect, the block header can include information to identify which of the instructions, of the block of instructions, stores information in the memory. In an aspect, the block header can include information to identify an order, according to the program order, of the instructions, of the block of instructions, that store information in the memory.

As described above, the block-based computer processor core can be configured so that at least one effectual instruction is executed before the causal instruction is executed. Additionally, the block-based architecture can be configured so that a result of a causal instruction can be an operand for an effectual instruction. In other words, the causal instruction can be a producing instruction and the effectual instruction can be a consuming instruction. In this case such an operand can be referred to as a predicate. Because a block-based architecture can be configured so that an instruction is not executed by an execution unit until all of the operands needed by the instruction have been received by the execution unit, having the result of the causal instruction be an operand for the effectual instruction advantageously can prevent the block-based computer processor core from needlessly executing the effectual instruction. Preventing the block-based computer processor core from needlessly executing the effectual instruction advantageously can reduce an amount of power consumed by the block-based computer processor core.

For example, the block-based architecture can be configured so that if the result of the causal instruction indicates that the condition is valid, this result can be a predicate operand for the valid condition instruction(s) so that the execution unit(s) for the valid condition instruction(s) can be configured to execute the valid condition instruction(s); however, this result would not be a predicate operand for the invalid condition instruction(s) so that the execution unit(s) for the invalid condition instruction(s) can be prevented from needlessly executing the invalid condition instruction(s). Likewise, for example, if the result of the causal instruction indicates that the condition is not valid, this result can be a predicate operand for the invalid condition instruction(s) so that the execution unit(s) for the invalid condition instruction(s) can be configured to execute the valid condition instruction(s); however, this result would not be a predicate operand for the valid condition instruction(s) so that the execution unit(s) for the valid condition instruction(s) can be prevented from needlessly executing the valid condition instruction(s).

As described above, both the causal instruction and the effectual instruction(s) can be assigned to the same block of instructions. Additionally, the causal instruction and at least one of the effectual instruction(s) can be assigned to different blocks of instructions. Because the causal instruction and at least one of the effectual instruction(s) can be assigned to different blocks of instructions, the block-based computer processor core can be configured to include a block predictor. The block predictor can be configured to predict which block of instructions, among the blocks of instructions included in the computer program, includes the at least one of the effectual instruction(s) that is likely to be executed based upon a result of the causal instruction included in a current block of instructions. In an aspect, the block predictor can use information in the block header of the current block of instructions to predict which block of instructions, among the blocks of instructions included in the computer program, includes the at least one of the effectual instruction(s) that is likely to be executed based upon the result of the causal instruction included in the current block of instructions. In an aspect, such a prediction can be made after the block header of the current block of instructions has been fetched, but before instructions of the current block of instructions commence being executed. In an aspect, as a result of such a prediction, after the instructions of the current block of instructions commence being executed, but before the instructions of the current block of instructions complete being executed, the block header of the block of instructions that includes the predicted at least one of the effectual instruction(s) that is likely to be executed based upon the result of the causal instruction can be fetched. In an aspect, as a result of such a prediction, after the instructions of the current block of instructions commence to be executed, but before the instructions of the current block of instructions complete being executed, instructions of the block of instructions that includes the predicted at least one of the effectual instruction(s) that is likely to be executed based upon the result of the causal instruction can commence being executed.

In an aspect, the block predictor can be configured to predict an execution path in a manner similar to that of a branch predictor in a conventional OOO computer processing unit. In an aspect, the compiler of a block-based computer processing unit can be configured to execute dataflow test instructions to convert branching instructions into a directed acyclic graph (DAG) of predicates. In an aspect, the block predictor can be configured to store predictions in prediction tables and to distribute at least portions of these prediction tables across block-based computer processor cores. In an aspect, the block predictor can be configured to produce information about a degree of confidence of a prediction. In an aspect, the block predictor can be configured to predict a next block of instructions to be executed following execution of a current block of instructions based upon the execution path determined by the predicates, a history of previously executed blocks of instructions, or both.

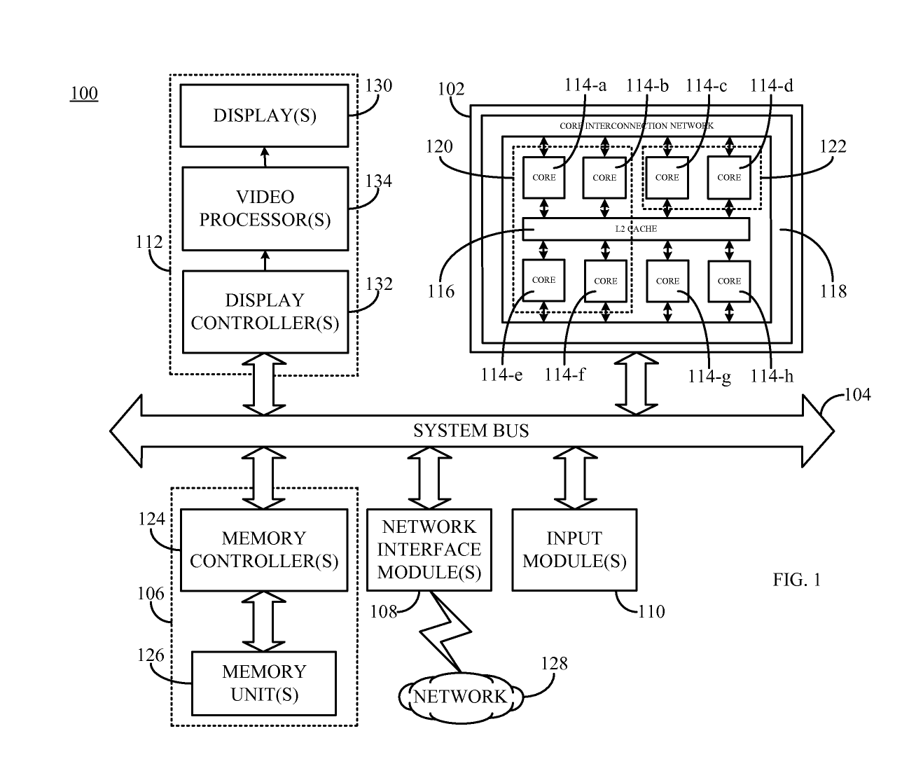

FIG. 1 is a block diagram illustrating an example of a system 100 in which a block-based computer processing unit 102 can operate. The system 100 can include by way of example, and not by way of limitation, at least one block-based computer processing unit 102, a system bus 104, at least one memory system 106, at least one network interface module 108, at least one input module 110, and at least one output module 112.

The at least one block-based computer processing unit 102 can include at least one block-based computer processor core 114, a level-2 (L2) cache 116, and, optionally, a core interconnection network 118. By way of example, and not by way of limitation, eight block-based computer processor cores 114-a, 114-b, 114-c, 114-d, 114-e, 114-f, 114-g, and 114-h are illustrated in FIG. 1. The at least one block-based computer processor core 114 can be configured to access the L2 cache 116 to receive at least one block of instructions to be executed, to store a result of an execution of the at least one block of instructions, or both.

In an aspect in which the block-based computer processing unit 102 includes multiple block-based computer processor cores 114, the core interconnection network 118 can be used to facilitate communication among the block-based computer processor cores 114. For example, the block-based computer processing unit 102 can be configured to cause, via the core interconnection network 118, the at least one block-based computer processor core 114 to be configured to operate independently, to be configured to operate in conjunction with at least one other of the at least one block-based computer processor core 114, or a combination of the foregoing. When the block-based computer processing unit 102 is configured to cause the at least one block-based computer processor core 114 to operate in conjunction with at least one other of the at least one block-based computer processor core 114 such a configuration can be referred to as a core composition or a core fusion.

For example, to execute an application program in a parallel manner on multi-threaded sections, such as can be done by a graphics processing unit (GPU) or a digital signal processor (DSP), the block-based computer processing unit 102 can configure one block-based computer processor core 114 to operate independently on one of the multi-threaded sections and at least one other block-based computer processor core 114 to operate on at least one other of the multi-threaded sections. For example, to execute an application program efficiently on a single thread, such as can be done by a central processing unit (CPU), the block-based computer processing unit 102 can configure one block-based computer processor core 114 to operate in conjunction with at least one other block-based computer processor core 114. By way of example, and not by way of limitation, FIG. 1 illustrates a configuration in which: (1) each of the block-based computer processor cores 114-a, 114-b, 114-e, and 114-f is configured to operate in conjunction with each other of the computer processor cores 114-a, 114-b, 114-e, and 114-f as a first core composition 120, (2) the block-based computer processor core 114-c is configured to operate in conjunction with the block-based computer processor core 114-d as a second core composition 122, (3) the block-based computer processor core 114-g is configured to operate independently, and (4) the block-based computer processor core 114-h is configured to operate independently. First core composition 120 can be configured to execute a first application program. Second core composition 122 can be configured to execute a second application program. The block-based computer processor core 114-g can be configured to execute a first thread of a third application program and the block-based computer processor core 114-h can be configured to execute a second thread of the third application program. Alternatively, the block-based computer processor core 114-g can be configured to execute the third application program and the block-based computer processor core 114-h can be configured to execute the fourth application program.

The at least one block-based computer processing unit 102 can be coupled to the system bus 104 and can communicate with other devices of the system 100 by exchanging address, control, and data information via the system bus 104.

The at least one memory system 106 can include at least one memory controller 124 and at least one memory unit 126. The memory system 106 can be coupled to the system bus 104. The at least one memory unit 126 can include by way of example, and not by way of limitation, a random access memory (RAM) unit.

The at least one network interface module 108 can include hardware, software, or a combination of both configured to facilitate exchange of data to and from a network 128. The at least one network interface module 108 can be configured to support at least one communications protocol. The at least one network interface module 108 can be coupled to the system bus 104. The network 128 can be any type of network including, but not limited to, a wired or wireless network, a public or private network, a personal area network (PAN), a local area network (LAN), a wide local area network (WLAN), and the Internet.

The at least one input module 110 can include by way of example, and not by way of limitation, a user interface, a graphical user interface, a keyboard, a pointing device (e.g., a mouse), a touchpad, a touchscreen, a switch, a button, a voice processor, the like, or any combination of the foregoing. The at least one input module 110 can be coupled to the system bus 104.

The at least one output module 112 can include by way of example, and not by way of limitation, a printer, a display, an audio output device, a graphic output device, a video output device, another visual indicator, the like, or any combination of the foregoing. The at least one output module 112 can be coupled to the system bus 104. In an aspect, the at least one output module 112 can include at least one display 130. The at least one display 130 can include, but is not limited to, a cathode ray tube, a liquid crystal display, a plasma display, a light-emitting diode display, an organic light-emitting diode display, the like, or any combination of the foregoing. The system 100 can further include at least one display controller 132 configured to receive control information from the at least one block-based computer processing unit 102 via the system bus 104. The at least one display controller 132 can be configured to send information to the at least one display 130 via at least one video processor 134. The at least one video processor 134 can be configured to receive the information from the at least one display controller 132, to process the information so that the information has a form that is compatible with the at least one display 130, and to send the processed information to the at least one display 130.

The system 100 can be incorporated, by way of example, and not by way of limitation, into a set top box, an entertainment unit, a navigation device, a communication device, a fixed location data unit, a mobile location data unit, a mobile phone, a cellular phone, a smartphone, a computer, a desktop computer, a portable computer, a laptop computer, a tablet computer, a personal digital assistant (PDA), a monitor, a computer monitor, a television, a tuner, a radio, a satellite radio, a music player, a digital music player, a portable music player, a video player, a digital video player, a portable digital video player, a digital video disc (DVD) player, the like, or any combination of the foregoing.

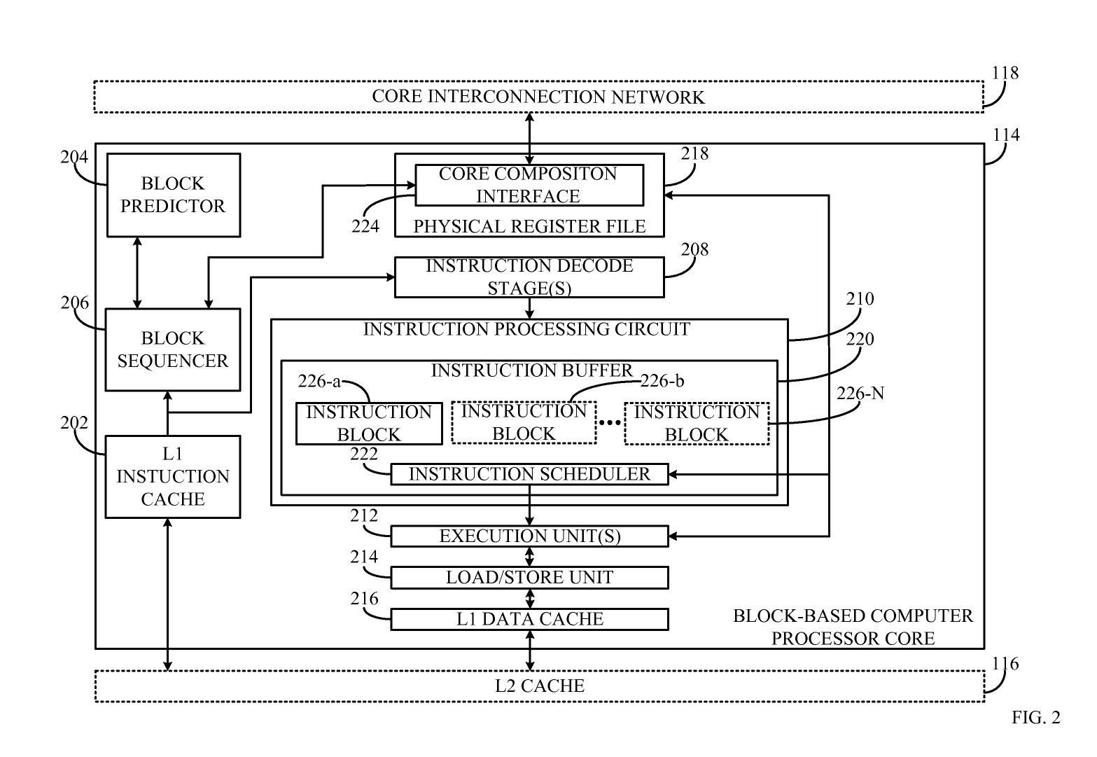

FIG. 2 is a block diagram illustrating an example of the block-based computer processor core 114. The block-based computer processor core 114 can be configured to be coupled to the L2 cache 116. The block-based computer processor core 114 can be configured to access the L2 cache 116 to receive at least one block of instructions to be executed, to store a result of an execution of the at least one block of instructions, or both. Optionally, the block-based computer processor core 114 can be configured to be coupled to the core interconnection network 118. In an aspect in which the block-based computer processing unit 102 includes multiple block-based computer processor cores 114, the core interconnection network 118 can be used to facilitate communication among the block-based computer processor cores 114.

The block-based computer processor core 114 can include any of several known digital logic elements, semiconductor circuits, processing cores, other elements, the like, or any combination thereof. Aspects described herein are not restricted to any particular arrangement of the elements and the disclosed techniques can be realized in various structures or layouts on semiconductor dies or packages.

The block-based computer processor core 114 can include by way of example, and not by way of limitation, a level-1 (L1) instruction cache 202, a block predictor 204, a block sequencer 206, at least one instruction decode stage 208, an instruction processing circuit 210, at least one execution unit 212, a load/store unit 214, a level-1 (L1) data cache 216, and a physical register file 218. By way of example, and not by way of limitation, the instruction processing circuit 210 can include an instruction buffer 220 and an instruction scheduler 222. In an aspect in which the block-based computer processing unit 102 includes multiple block-based computer processor cores 114, the block-based computer processor core 114 can include a core composition interface 224. By way of example, and not by way of limitation, the core composition interface 224 can be included in the physical register file 218.

The L1 instruction cache 202 can be configured to receive blocks of instructions 226 from the L2 cache 116. The L1 instruction cache 202 can be configured to transmit information to the L2 cache 116. The L1 instruction cache 202 can be configured to store the blocks of instructions 226. The L1 instruction cache 202 can be configured to transmit information about the blocks of instructions 226 to the block sequencer 206. The L1 instruction cache 202 can be configured to transmit the blocks of instructions 226 to the at least one instruction decode stage 208. For example, the L1 instruction cache 202 can be configured to receive blocks of instructions 226-a through 226-N from the L2 cache 116.

The block predictor 204 can be configured to predict a next block of instructions 226 to be executed following execution of a current block of instructions 226. In an aspect, the block predictor 204 can be configured to predict an execution path in a manner similar to that of a branch predictor in a conventional OOO computer processing unit. In an aspect, the block predictor 204 can be configured to predict a next block of instructions 226 to be executed following execution of a current block of instructions 226 based upon the execution path determined by predicates produced by executing dataflow test instructions to convert branching instructions into a directed acyclic graph (DAG), a history of previously executed blocks of instructions 226, or both. The block predictor 204 can be configured to receive the information about the blocks of instructions 226 from the block sequencer 206. The block predictor 204 can be configured to transmit information about a prediction to the block sequencer 206.

The block sequencer 206 can be configured to receive the information about the blocks of instructions 226 from the L1 instruction cache 202 and the information about the prediction from the block predictor 204. The block sequencer 206 can be configured to determine an order for the blocks of instructions 226. In an aspect in which the block-based computer processing unit 102 includes multiple block-based computer processor cores 114, the block sequencer 206 can be configured to exchange information with the core composition interface 224.

The at least one instruction decode stage 208 can be configured to receive the blocks of instructions 226 from the L1 instruction cache 202. The at least one instruction decode stage 208 can be configured to decode instructions in the blocks of instructions 226. For example, the at least one instruction decode stage 208 can be configured to decode the instructions in the blocks of instructions 226-a through 226-N. The at least one instruction decode stage 208 can be configured to transmit the instructions in the blocks of instructions 226 to the instruction processing circuit 210.

The instruction buffer 220 of the instruction processing circuit 210 can be configured to receive the blocks of instructions 226 from the at least one decode stage 208. The instruction buffer 220 can be configured to store the instructions of the blocks of instructions 226 in anticipation of executing the instructions.

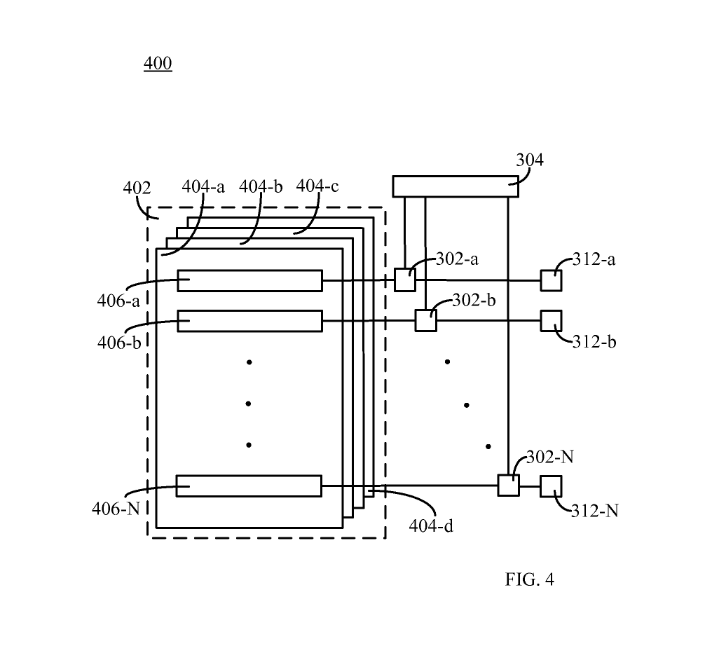

The instruction scheduler 222 of the instruction processing circuit 210 can be configured to transmit instructions, of the blocks of instructions 226 that have commenced the process of executing instructions, to the at least one execution unit 212. The number of blocks of instructions 226 that can be executed concurrently by a single block-based computer processor core 114 can within a range, inclusively, from one to a maximum number. The maximum number can be defined with respect to the microarchitecture of the computer processor core 114. For example, the maximum number of blocks of instructions 226 that can be executed concurrently can be equal to a number of arrays of reservation stations 402 (see FIG. 4) of the computer processor core 114. By way of example, and not by way of limitation, if the computer processor core 114 has four arrays of reservation stations, then the maximum number of blocks of instructions 226 that can be executed concurrently can be limited to four blocks of instructions 226. By way of example, and not by way of limitation, if the maximum number of blocks of instructions 226 that can be executed concurrently is limited to four blocks of instructions, then the blocks of instructions 226-a, 226-b, 226-c (not illustrated), and 226-d (not illustrated) can be executed concurrently.

An execution unit 212 of the at least one execution unit 212 can be configured to receive an instruction from the instruction scheduler 222. The execution unit 212 can be configured to receive an operand from at least one of: (1) a result of another instruction via the instruction scheduler 222, (2) a register of the physical register file 218, or (3) the at least one memory unit 126 via the load/store unit 214. The execution unit 212 can be configured to execute the instruction received from the instruction scheduler 222 in response to all of the operands needed by the instruction having been received by the execution unit 212. The execution unit 212 can be configured to transmit a result of the instruction to at least one of: (1) another instruction via the instruction scheduler 222, (2) a register of the physical register file 218, or (3) the at least one memory unit 126 via the load/store unit 214. By way of example, and not by way of limitation, the execution unit 212 can include at least one of an arithmetic logic unit (ALU) or a floating-point unit (FPU).

The load/store unit 214 can be configured receive data from the at least one execution unit 212. The load/store unit 214 can be configured to receive data from the at least one memory unit 126 via the L2 cache 116 and the L1 data cache 216. The load/store unit 214 can be configured to transmit data to the at least one execution unit 212. The load/store unit 214 can be configured to transmit data to the at least one memory unit 126 via the L1 data cache 216 and the L2 cache 116.

The L1 data cache 216 can be configured to receive data from the load/store unit 214. The L1 data cache 216 can be configured to receive data from the L2 cache 116. The L1 data cache 216 can be configured to store data. The L1 data cache 216 can be configured to transmit data to the load/store unit 214. The L1 data cache 216 can be configured to transmit data to the L2 cache 116.

The physical register file 218 can be configured to receive data from the at least one execution unit 212. The physical register file 218 can be configured to store data. The physical register file 218 can be configured to transmit data to the at least one execution unit 212. By way of example, and not by way of limitation, the physical register file 218 can include a random access memory (RAM) unit, such as a fast static RAM unit that can have at least one dedicated read port and at least one dedicated write port.

In an aspect in which the block-based computer processing unit 102 includes multiple block-based computer processor cores 114, the core composition interface 224 can be configured to exchange information with the block sequencer and to exchange information with the core interconnection network 118 to facilitate communication among the block-based computer processor cores 114.

As described above, a result of a producing instruction can be an operand for a consuming instruction and the producing instruction can be configured to include an identity of a location of a record, in an array of reservation stations, for the operand for the consuming instruction as the identity of the destination of the result of the producing instruction. However, often, the result of a single producing instruction can be an operand for many consuming instructions. This can be referred to as a fan out of the result of the producing instruction. Thus, there can be a need for the block-based microarchitecture to be configured to identify more than one destination of the result of the producing instruction.

In one approach to addressing this need, the producing instruction can be configured to include identities of locations of reservation stations, in the array of reservation stations, for operands for more than one consuming instruction as identities of the more than one destination of the result of the producing instruction. However, such an approach can consume a substantial amount of area to realize the extra memory cells needed to store the identities of the more than one destination of the result of the producing instruction. Furthermore, such an approach may provide only a limited degree of improvement. For example, an array of reservation stations in which each record includes a number of memory cells sufficient to store identities of two destinations of the result of the producing instruction may only provide a limited degree of improvement in a situation in which the result of the producing instruction is an operand for more than two consuming instructions.

This problem may be solved by providing: (1) a special set of memory cells such that an identity of a location of the special set of memory cells can be identified in the producing instruction as the destination of the result of the producing instruction and (2) a set of bits, in each of the instructions, designated to store an information such that a presence of the information in any of the instructions can cause a corresponding execution unit to receive a content of the special set of memory cells as an operand for that instruction. In this manner, the result of the producing instruction can be stored in the special set of memory cells and each consuming instruction can be configured to include the information to cause the corresponding execution unit to receive the content of the special set of memory cells as an operand for that instruction.

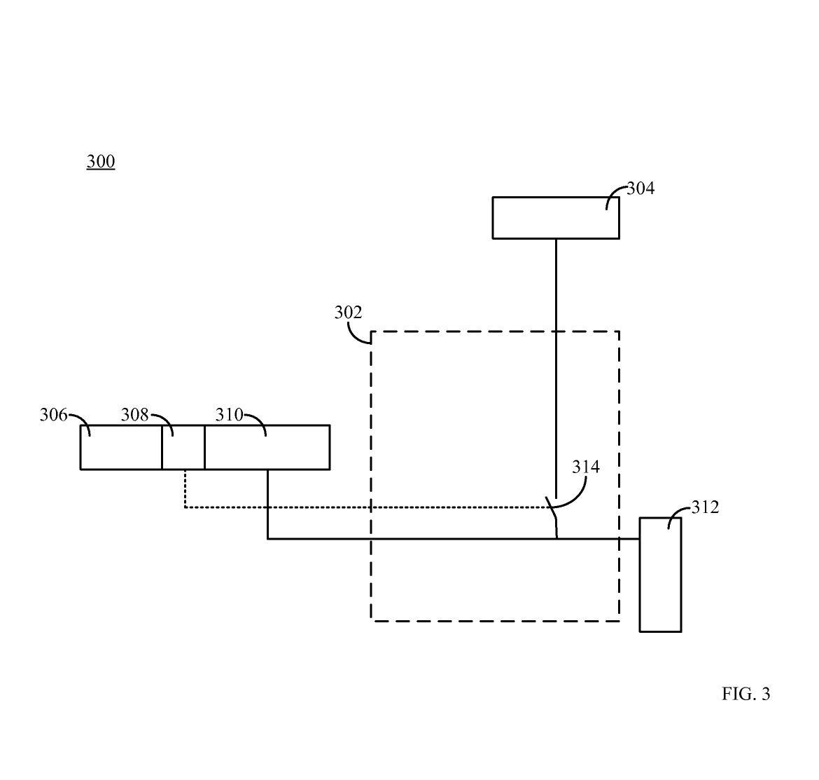

FIG. 3 is a block diagram illustrating an example of an apparatus 300 for fan out of a result of an instruction. The apparatus 300 can include memory cells and a first circuitry 302. The memory cells can include a first set 304, a second set 306, a third set 308, and a fourth set 310. The first set 304 can be configured to store the result of the first instruction. The first instruction can be a producing instruction. The second set 306 can be configured to store an operation code (i.e., an opcode) of a second instruction. The second instruction can be a consuming instruction. The third set 308 can be configured to store an information of the second instruction. The fourth set 310 can be configured to store an operand for the second instruction. The first circuitry 302 can be configured to connect the fourth set 310 to an execution unit 312 and configured to cause, in response to a presence of the information in the third set 308, the execution unit 312 to be configured to receive a content of the first set 304 as the operand for the second instruction. The execution unit 312 can be one of the at least one execution unit 212 (see FIG. 2).

For example, the first circuitry 302 can be configured to make a determination of the presence of the information in the third set 308 and to select, in response to the determination, a source of the operand for the second instruction. For example, the first circuitry 302 can be configured so that the fourth set 310 can be a first candidate for a destination of the result of the first instruction. For example, the first circuitry 302 can be configured so that the first set 304 can be a second candidate for the destination of the result of the first instruction. For example, the first circuitry 302 can be configured to select, in response to the presence of the information in the third set 308, the content of the first set 304 as the source of the operand for the second instruction.

The first set 304, the second set 306, the third set 308, and the fourth set 310 can be disjoint. A format of the second instruction can include a set of bits designated for the operation code and a set of bits designated for the information. For example, the set of bits designated for the information can be a single bit. The information can be a value of the bit

In an aspect, each memory cell of the second set 306 can include a random access memory cell. Each memory cell of the third set 308 can include a flip-flop. The information stored in the third set 308 can be represented by a single bit or a few number of bits. Advantageously, a flip-flop can change state more quickly than can a conventional random access memory cell.

In an aspect, the first circuitry 302 can include at least one switch 314. For example, the at least one switch 314 can be configured so that the execution unit 312 can be configured to receive a content of the fourth set 310 regardless of a position of the at least one switch 314, but configured to receive the content of the first set 304 only if the position of the at least one switch 314 is closed. The compiler can be configured to recast the source program in a manner so that, in response to the presence of the information in the third set 308, a result of a producing instruction is not stored in the fourth set 310. The at least one switch 314 can include a relay, a microelectromechanical switch, a semiconductor device, a transistor, a multiplexer, a pass gate, the like, or any combination of the foregoing.

FIG. 4 is a block diagram illustrating an example of an environment 400 of the apparatus 300. The environment 400 can include a set of arrays of reservation stations 402. For example, the set of arrays of reservation stations 402 can be included in the instruction scheduler 222 (see FIG. 2). The set of arrays of reservation stations 402 can include at least one array 404. By way of example, and not by way of limitation, arrays 404-a, 404-b, 404-c, and 404-d are illustrated in FIG. 4. Each array 404 can include at least one reservation station record 406. For example, N records 406-a, 406-b, . . . , 406-N are illustrated in the array 404-a in FIG. 4. By way of example, and not by way of limitation, N can be 32. Each record 406 can include the second set 306, the third set 308, and the fourth set 310. Each record 406 can have a corresponding first circuitry 302. For example, as illustrated in FIG. 4, the record 406-a can have the corresponding first circuitry 302-a, the record 406-b can have the corresponding first circuitry 302-b, and the record 406-n can have the corresponding first circuitry 302-N.

Each first circuitry 302 can have a corresponding execution unit 312. For example, as illustrated in FIG. 4, the first circuitry 302-a can have the corresponding execution unit 312-a, the first circuitry 302-b can have the corresponding execution unit 312-b, and the first circuitry 302-N can have the corresponding execution unit 312-N. Alternatively, rather than having each first circuitry 302 having a corresponding execution unit 312, another circuitry (not illustrated) can be coupled between each first circuitry 302 and a fewer number of execution units 312. The other circuitry can be a priority encoder or an arbiter. The other circuitry can be configured to coordinate routing each instruction that has received all of the operands needed by the instruction to one of the fewer number of execution units 312. The fewer number of execution units 312 can be as few as two execution units 312. The fewer number of execution units 312 can be as few as one execution unit 312. Advantageously, using a fewer number of execution units 312 can allow area otherwise consumed to realize a large number of execution units 312 to be available for other circuitry.

The set of arrays of reservation stations 402 can exclude the first set 304. In an aspect, the first set 304 can be configured as a register. For example, the register can be included in the physical register file 218 (see FIG. 2). However, a function of the first set 304 can be different from a function of a conventional register of the physical register file 218. In an aspect, the first set 304 can be configured as a random access memory in the block-based computer processor core 114 (see FIGS. 1 and 2) with the first circuitry (e.g., the first circuitry 302-a, 302-b, . . . , 302-N) configured so that data stored in the first set 304 can be accessible by any execution unit (e.g., any of the execution units 312-a, 312-b, . . . , 312-N) that corresponds to the array (e.g., the array 404-a) without a requirement that the data traverse a cache (e.g., the L2 cache 116) between the first set 304 and the any execution unit (e.g., any of the execution units 312-a, 312-b, . . . , 312-N).

For example, the record 406-a can be configured to store the first instruction and the record 406-b can be configured to store the second instruction. The first instruction can be a producing instruction. The result of the first instruction can be stored in the first set 302. The second instruction can be a consuming instruction. In response to the presence of the information in the third set 308 of the second instruction, the first circuitry 302-b can cause the execution unit 312-b to be configured to receive the content of the first set 304 as the operand for the second instruction. Additionally, another instruction can be a consuming instruction (e.g., an N instruction stored in the record 406-N). In response to the presence of the information in the third set of the other instruction (e.g., the N instruction), the corresponding first circuitry (e.g., the first circuitry 302-N) can cause the corresponding execution unit (e.g., the execution unit 312-N) to be configured to receive the content of the first set 304 as the operand for the other instruction (e.g., the N instruction). In this manner, the result of the first instruction can be an operand for the second instruction and for the other instruction (e.g., the N instruction). In other words, in this manner, a fan out of the result of the first instruction can be achieved.

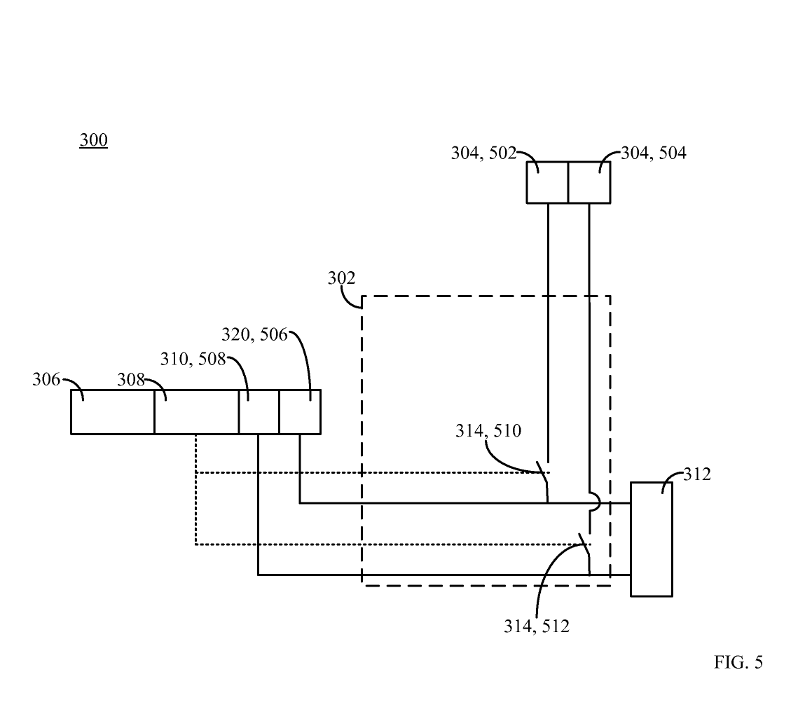

FIG. 5 is a block diagram illustrating an example of a variation of the apparatus 300. In an aspect, the first set 304 can include a first subset 502 and a second subset 504. The fourth set 310 can include a third subset 506 and a fourth subset 508. The third subset 506 can be configured to store a first operand of the second instruction. The fourth subset 508 can be configured to store a second operand of the second instruction. The first circuitry 302 can be configured to cause, in response to the presence of the information in the third set 308, the execution unit 312 to be configured to receive a content of the first subset 502 as the first operand for the second instruction. The first circuitry 302 can be configured to cause, in response to the presence of the information in the third set 308, the execution unit 312 to be configured to receive a content of the second subset 504 as the second operand for the second instruction.

For example, the at least one switch 314 can include a first switch 510 and a second switch 512. For example, the first switch 510 can be configured so that the execution unit 312 can be configured to receive a content of the third subset 506 regardless of a position of the first switch 510, but configured to receive the content of the first subset 502 only if the position of the first switch 510 is closed. For example, the second switch 512 can be configured so that the execution unit 312 can be configured to receive a content of the fourth subset 508 regardless of a position of the second switch 512, but configured to receive the content of the second subset 504 only if the position of the second switch 512 is closed. The compiler can be configured to recast the source program in a manner so that, in response to the presence of the information in the third set 308, a result of a producing instruction is not stored in the third subset 506, the fourth subset 508, or both.

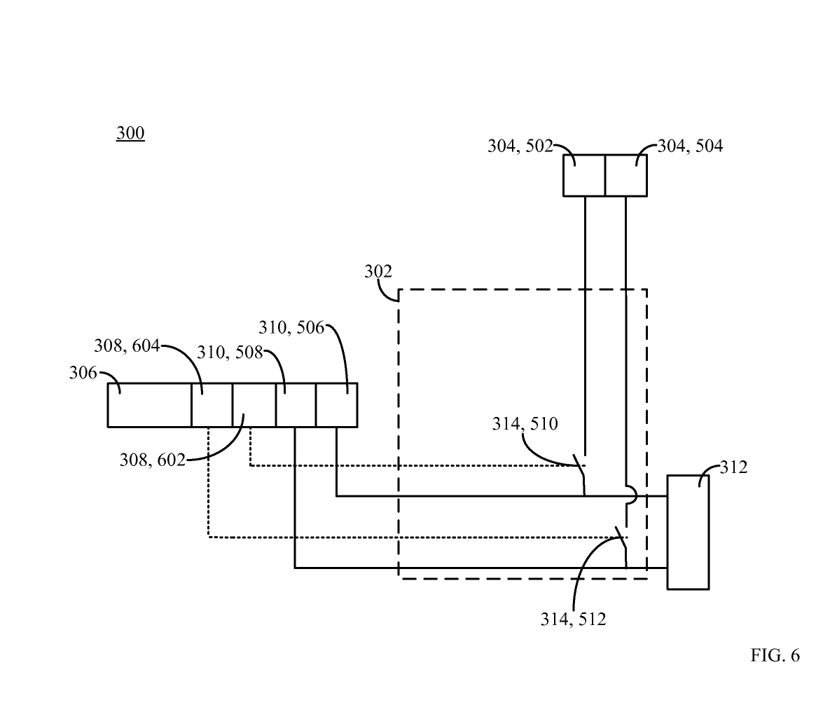

FIG. 6 is a block diagram illustrating an example of another variation of the apparatus 300. In an aspect, the third set 308 can include a fifth subset 602 and a sixth subset 604. The fifth subset 602 can be configured to store a first information of the second instruction. The sixth subset 604 can be configured to store a second information of the second instruction. The first circuitry 302 can be configured to cause, in response to a presence of the first information in the fifth subset 602, the execution unit 312 to be configured to receive the content of the first subset 502 as the first operand for the second instruction. The first circuitry 302 can be configured to cause, in response to a presence of the second information in the sixth subset 604, the execution unit 312 to be configured to receive the content of the second subset 504 as the second operand for the second instruction. In this manner, the first switch 510 and the second switch 512 can be operated independently of each other.

Alternatively, the first switch 510, the second switch 512, or both can be configured to have two contacts. For example, the first switch 510 can have a first contact (not illustrated) and a second contact. The first contact can be configured to connect the execution unit 312 to the third subset 506. The second contact can be configured to connect the execution unit 312 to the first subset 502. For example, the second switch 512 can have a first contact (not illustrated) and a second contact. The first contact can be configured to connect the execution unit 312 to the fourth subset 508. The second contact can be configured to connect the execution unit 312 to the second subset 504.

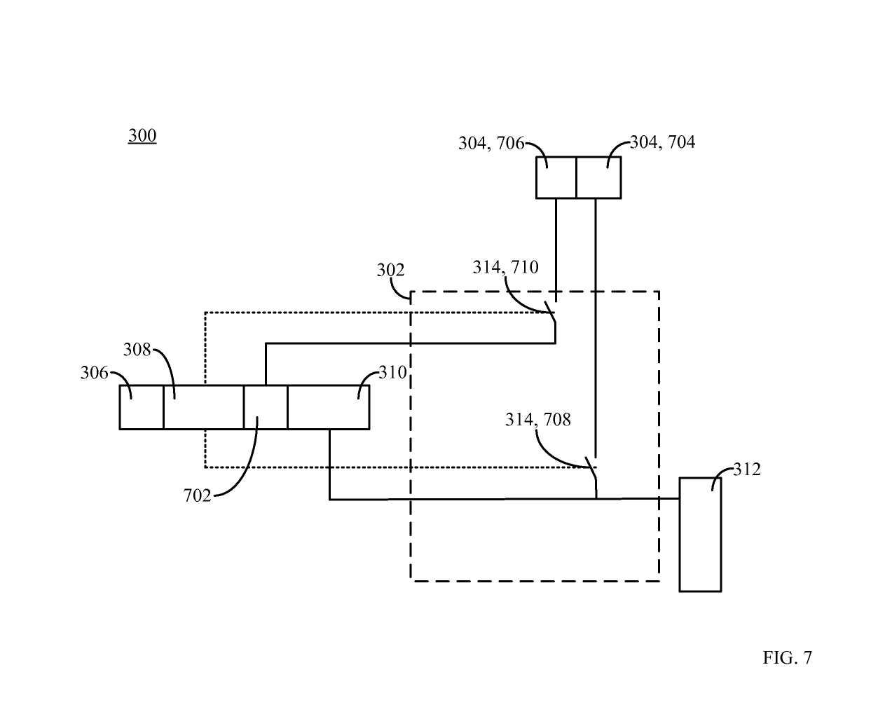

FIG. 7 is a block diagram illustrating an example of another variation of the apparatus 300. In an aspect, the memory cells can further include a fifth set 702 configured to store a predicate operand of the second instruction. The format of the instruction can further include a set of bits designated for the predicate operand. The first set 304 can include a first subset 704 and a second subset 706. The first circuitry 302 can be configured to cause, in response to the presence of the information in the third set 308, the execution unit 312 to be configured to receive a content of the first subset 704 as the operand for the second instruction. The first circuitry 302 can be configured to cause, in response to the presence of the information in the third set 308, the fifth set 702 to be configured to receive a content of the second subset 706 as the predicate operand of the second instruction. For example, the first circuitry 302 can be configured to select, in response to the presence of the information in the third set 308, the content of the second subset 706 as the source of the predicate operand of the second instruction.

For example, the at least one switch 314 can include a first switch 708 and a second switch 710. For example, the first switch 708 can be configured so that the execution unit 312 can be configured to receive the content of the fourth set 310 regardless of a position of the first switch 708, but configured to receive the content of the first subset 704 only if the position of the first switch 708 is closed.

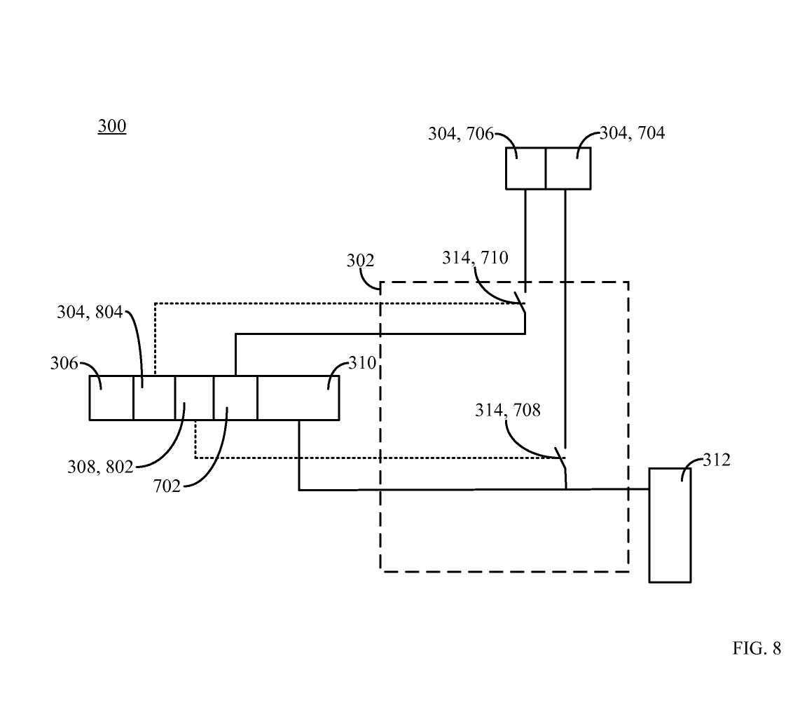

FIG. 8 is a block diagram illustrating an example of another variation of the apparatus 300. In an aspect, the third set 308 can include a third subset 802 and a fourth subset 804. The third subset 802 can be configured to store a first information of the second instruction. The fourth subset 804 can be configured to store a second information of the second instruction. The first circuitry 302 can be configured to cause, in response to a presence of the first information in the third subset 802, the execution unit 312 to be configured to receive the content of the first subset 704 as the operand for the second instruction. The first circuitry 302 can be configured to cause, in response to a presence of the second information in the fourth subset 804, the fifth set 702 to be configured to receive the content of the second subset 706 as the predicate operand of the second instruction. For example, the first circuitry 302 can be configured to select, in response to the presence of the information in the third set 308, the content of the second subset 706 as the source of the predicate operand of the second instruction. In this manner, the first switch 708 and the second switch 710 can be operated independently of each other.

Alternatively, the first switch 708 can be configured to have two contacts. For example, the first switch 708 can have a first contact (not illustrated) and a second contact. The first contact can be configured to connect the execution unit 312 to the fourth set 310. The second contact can be configured to connect the execution unit 312 to the first subset 704.

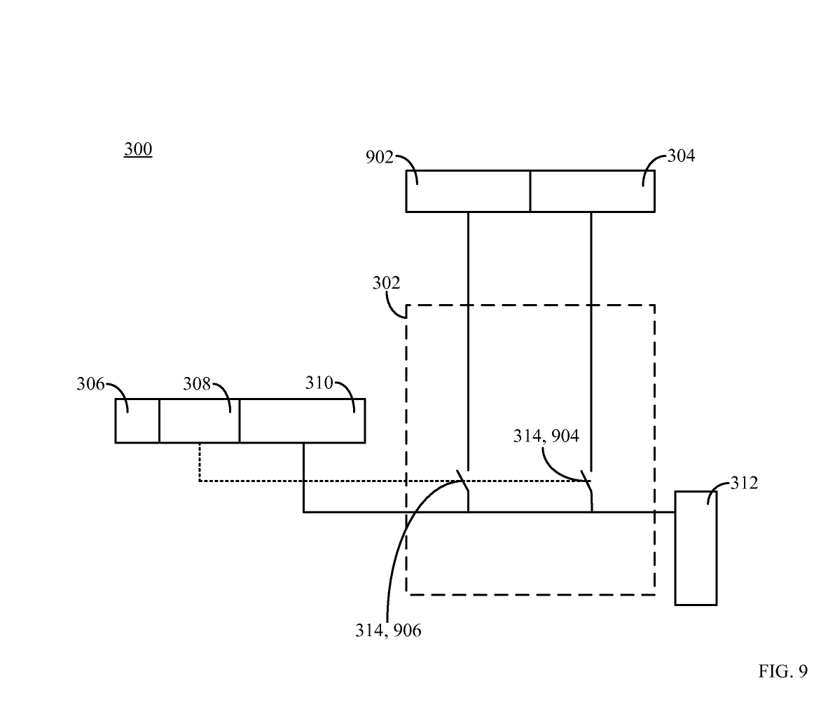

FIG. 9 is a block diagram illustrating an example of another variation of the apparatus 300. In an aspect, the memory cells can further include a fifth set 902 configured to store the result of the first instruction (or another instruction). The information can be configured to have a first value or a second value. Alternatively, the information can include a first information or a second information. The first circuitry 302 can be configured to cause, in response to the presence of the information having the first value in the third set 308, the execution unit 312 to be configured to receive the content of the first set 304 as the operand for the second instruction. For example, the first circuitry 302 can be configured to select, in response to the presence of the first information in the third set 308, the content of the first set 304 as the source of the operand for the second instruction. The first circuitry 302 can be configured to cause, in response to the presence of the information having the second value in the third set 308, the execution unit 312 to be configured to receive the content of the fifth set 902 as the operand for the second instruction. For example, the first circuitry 302 can be configured to select, in response to the presence of the second information in the third set 308, the content of the fifth set 902 as the source of the operand for the second instruction.

For example, the at least one switch 314 can include a first switch 904 and a second switch 906. For example, the first switch 904 can be configured so that the execution unit 312 can be configured to receive the content of the fourth set 310 regardless of a position of the first switch 904, but configured to receive the content of the first set 304 only if the position of the first switch 902 is closed. The second switch 906 can be configured so that the execution unit 312 can be configured to receive the content of the fourth set 310 regardless of a position of the second switch 906, but configured to receive the content of the fifth set 902 only if the position of the second switch 904 is closed.

Alternatively, the first switch 904, the second switch 906, or both can be configured to have two contacts. For example, the first switch 904 can have a first contact (not illustrated) and a second contact. The first contact can be configured to connect the execution unit 312 to the fourth set 310. The second contact can be configured to connect the execution unit 312 to the first set 304. For example, the second switch 906 can have a first contact (not illustrated) and a second contact. The first contact can be configured to connect the execution unit 312 to the fourth set 310. The second contact can be configured to connect the execution unit 312 to the fifth set 902.

Alternatively, the at least one switch 314 can include one switch (not illustrated) configured to have two contacts. For example, the one switch can have a first contact (not illustrated) and a second contact (not illustrated). The one switch can be configured to close, in response to the presence of the information having the first value in the third set 308, to the first contact to connect the execution unit 312 to the first set 304. The one switch can be configured to close, in response to the presence of the information having the second value in the third set 308, to the second contact to connect the execution unit 312 to the fifth set 902.

The set of bits designated for the information of the second instruction can be configured to represent a binary number. For example, the binary number 00 can indicate a lack of a presence of the information in the third set 308 so that the execution unit 312 can be configured to receive the content of the fourth set 310 as the operand for the second instruction. For example, the binary number 01 can be the first value so that the execution unit 312 can be configured to receive the content of the first set 304 as the operand for the second instruction. For example, the binary number 10 can be the second value so that the execution unit 312 can be configured to receive the content of the fifth set 902 as the operand for the second instruction. If the apparatus is configured so that the memory cells include a sixth set (not illustrated) configured to store the result of the first instruction, then the binary number 11 can be used as a value so that the execution unit 312 can be configured to receive a content of the sixth set (not illustrated) as the operand for the second instruction. Advantageously, if the set of bits designated for the information of the second instruction are configured to represent a binary number, then three different sets can be represented with two bits.

Alternatively, the set of bits designated for the information of the second instruction can be configured as a bitmap. (See FIG. 6.) For example, the set of bits stored in the fifth subset 602 can correspond to the first subset 502 and the set of bits stored in the sixth subset 604 can correspond to the second subset 504. For example, 00 in the bit map (0 stored in fifth subset 602 and 0 stored in sixth subset 604) can indicate a lack of presence of the information in the third set 308 so that the execution unit 312 can be configured to receive the content of the fourth set 310 (third subset 506 and fourth subset 508) as the operands for the second instruction. For example, 01 in the bit map (1 stored in fifth subset 602 and 0 stored in sixth subset 604) can cause the execution unit 312 to be configured to receive the content of the first subset 502 as the first operand for the second instruction. For example, 10 in the bit map (0 stored in fifth subset 602 and 1 stored in sixth subset 604) can cause the execution unit 312 to be configured to receive the content of the second subset 504 as the second operand for the second instruction. For example, 11 in the bit map (1 stored in fifth subset 602 and 1 stored in sixth subset 604) can cause the execution unit 312 to be configured to receive the content of the first subset 502 as the first operand for the second instruction and to receive the content of the second subset 504 as the second operand for the second instruction. Advantageously, if the set of bits designated for the information of the second instruction are configured as a bitmap so that each position of the set of bits corresponds to a subset configured to store the result of the first instruction (or another instruction), then two bits can be used to cause the execution unit 312 to be configured to receive contents of two subsets.

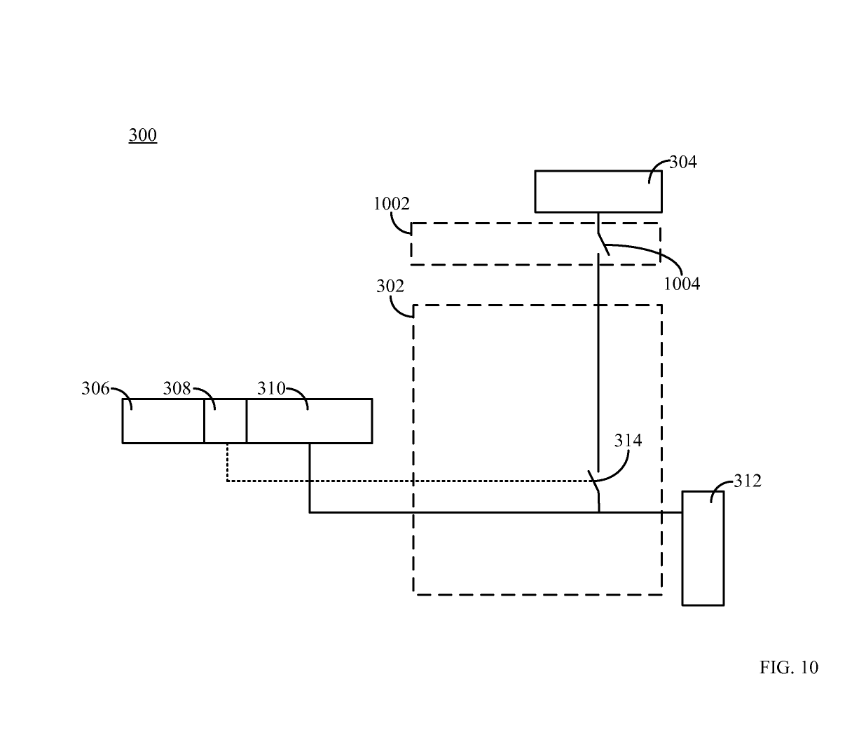

FIG. 10 is a block diagram illustrating an example of another variation of the apparatus 300. In an aspect, the apparatus 300 can further include a second circuitry 1002. The second circuitry 1002 can be configured to prevent the execution unit 312 from being configured to receive the content of the first set 304 until after the result of the first instruction has been stored in the first set 304. In an aspect, the second circuitry 1002 can include at least one switch 1004. The at least one switch 1004 can include a relay, a microelectromechanical switch, a semiconductor device, a transistor, a multiplexer, a pass gate, the like, or any combination of the foregoing. For example, because the first set 304 may have values stored therein before the computer processor core 114 commences to execute a current block of instructions, the at least one switch 1004 can be configured to be open until after the result of the first instruction has been stored in the first set 304. In this manner, the execution unit 312 can be prevented from erroneously receiving values stored in the first set 304 before the result of the first instruction has been stored in the first set 304. The at least one switch 1004 can be configured to be closed in response to the result of the first instruction having been stored in the first set 304.

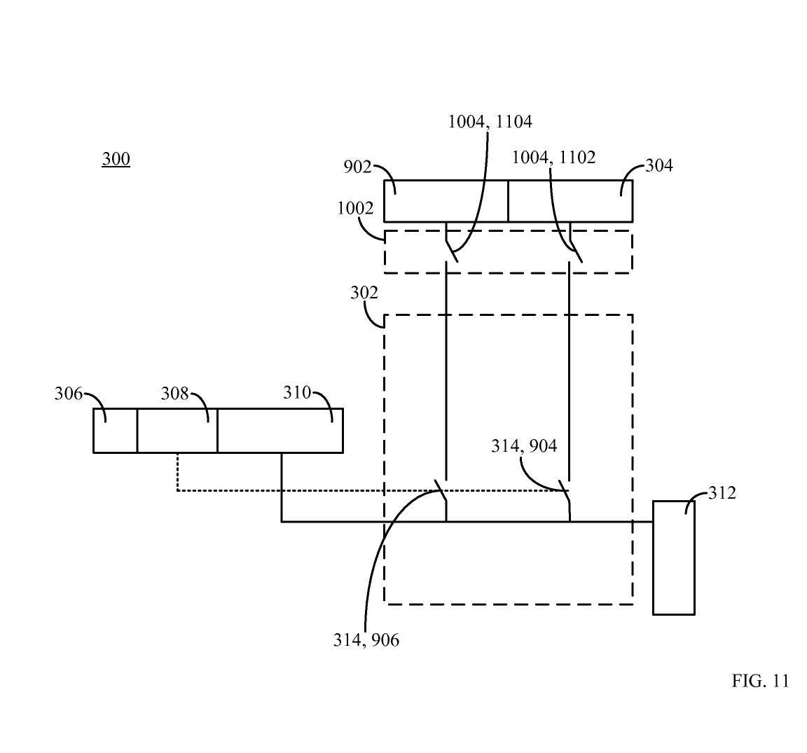

FIG. 11 is a block diagram illustrating another variation of the apparatus 300. In an aspect, the memory cells can further include the fifth set 902 configured to store the result of the first instruction (or another instruction). The second circuitry 1002 can be further configured to prevent the execution unit 312 from being configured to receive the content of the fifth set 902 until after the result of the first instruction (or another instruction) has been stored in the fifth set 902. For example, the at least one switch 1004 can include a first switch 1102 and a second switch 1104. For example, the first switch 1102 can be configured to prevent the execution unit 312 from being configured to receive the content of the first set 304 until after the result of the first instruction has been stored in the first set 304. For example, the second switch 1104 can be configured to prevent the execution unit 312 from being configured to receive the content of the fifth set 902 until after the result of the first instruction (or another instruction) has been stored in the fifth set 902.

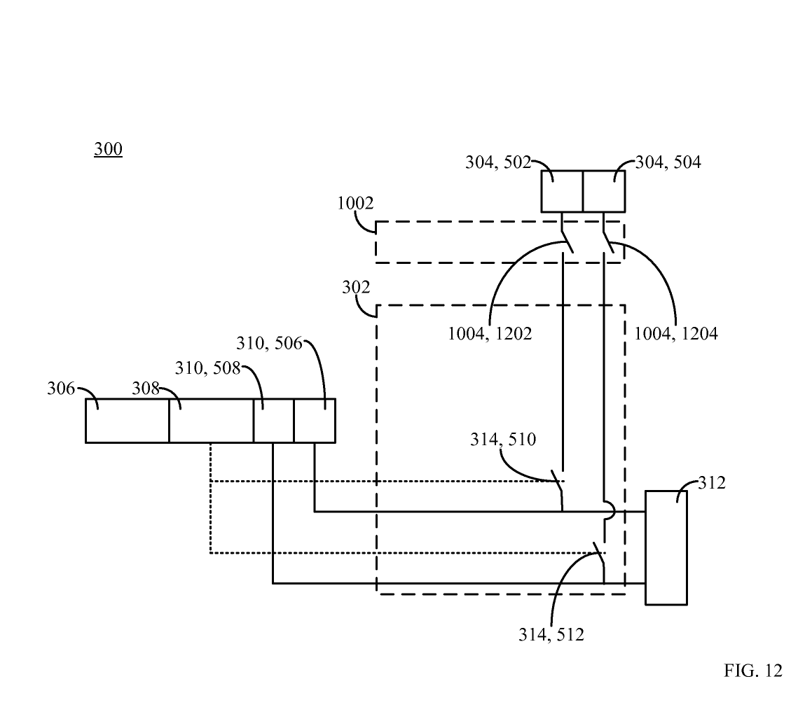

FIG. 12 is a block diagram illustrating another variation of the apparatus 300. In an aspect, the first set 304 can include the first subset 502 and the second subset 504. The second circuitry 1002 can be configured to prevent the execution unit 312 from being configured to receive the content of the first set 304 until after the result of the first instruction has been stored in the first subset 502, the second subset 504, or both. For example, the at least one switch 1004 can include a first switch 1202 and a second switch 1204. For example, the first switch 1202 and the second switch 1204 can be configured to prevent the execution unit 312 from being configured to receive the content of the first set 304 until after the result of the first instruction has been stored in the first subset 502, the second subset 504, or both. For example, in response to the result of the first instruction having been stored in the first subset 502, the second subset 504, or both, both the first switch 1202 and the second switch 1204 can be closed.

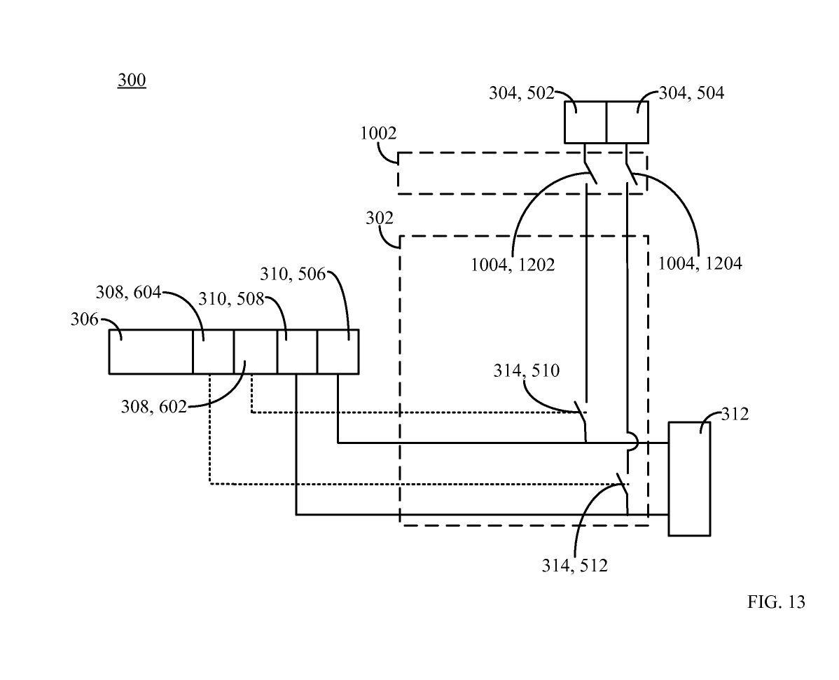

FIG. 13 is a block diagram illustrating another variation of the apparatus 300. In an aspect, the first set 304 can include the first subset 502 and the second subset 504. The second circuitry 1002 can be configured to prevent the execution unit 312 from being configured to receive the content of the first subset 502 until after the result of the first instruction has been stored in the first subset 502. The second circuitry 1002 can be configured to prevent the execution unit 312 from being configured to receive the content of the second subset 504 until after the result of the first instruction has been stored in the second subset 504. For example, the at least one switch 1004 can include the first switch 1202 and the second switch 1204. For example, the first switch 1202 can be configured to prevent the execution unit 312 from being configured to receive the content of the first subset 502 until after the result of the first instruction has been stored in the first subset 502. For example, the second switch 1204 can be configured to prevent the execution unit 312 from being configured to receive the content of the second subset 504 until after the result of the first instruction has been stored in the second subset 504. In this manner, the first switch 1202 and the second switch 1204 can be operated independently of each other.

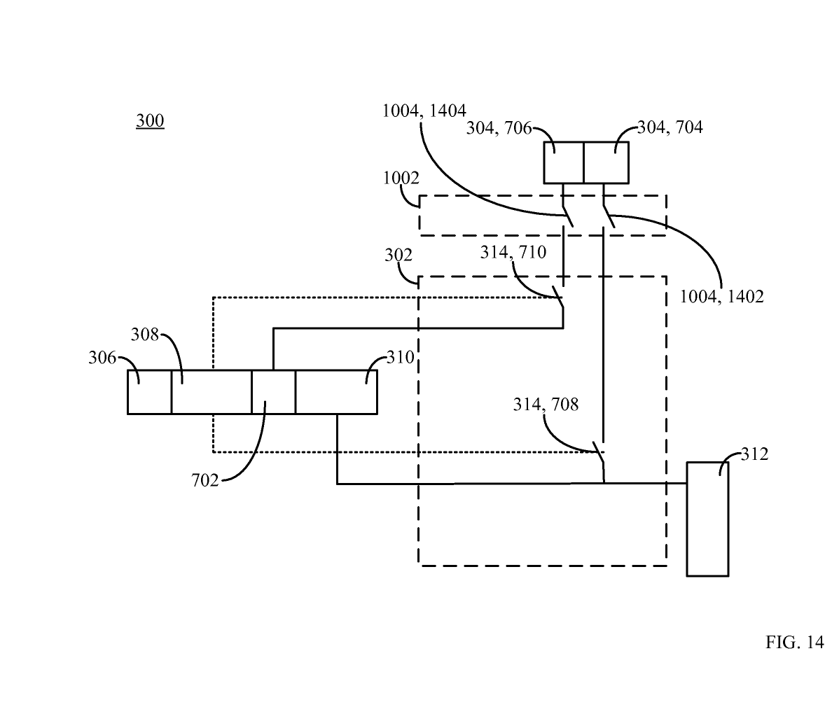

FIG. 14 is a block diagram illustrating another variation of the apparatus 300. In an aspect, the first set 304 can include the first subset 704 and the second subset 706. The memory cells can further include the fifth set 702 configured to store a predicate operand of the second instruction. The format of the second instruction can further include a set of bits designated for the predicate operand. The second circuitry 1002 can be configured to prevent the execution unit 312 and the fifth set 702 from being configured to receive the content of the first set 304 until after the result of the first instruction has been stored in the first subset 704, the second subset 706, or both. For example, the at least one switch 1004 can include a first switch 1402 and a second switch 1404. For example, the first switch 1402 and the second switch 1404 can be configured to prevent the execution unit 312 and the fifth set 702 from being configured to receive the content of the first set 304 until after the result of the first instruction has been stored in the first subset 704, the second subset 706, or both. For example, in response to the result of the first instruction having been stored in the first subset 704, the second subset 706, or both, both the first switch 1402 and the second switch 1404 can be closed.

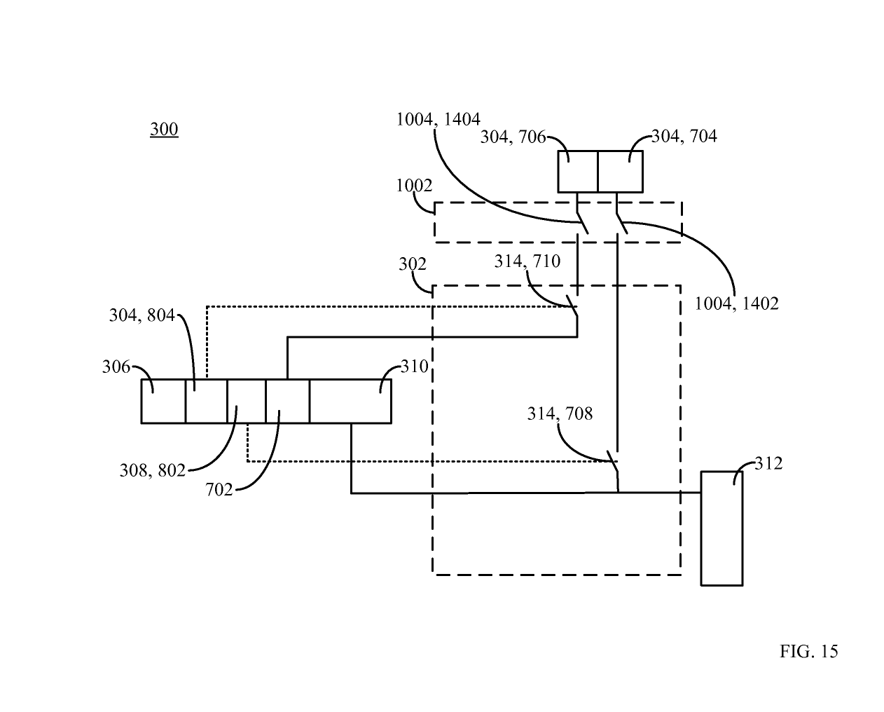

FIG. 15 is a block diagram illustrating another variation of the apparatus 300. In an aspect, the first set 304 can include the first subset 704 and the second subset 706. The memory cells can further include the fifth set 702 configured to store a predicate operand of the second instruction. The format of the second instruction can further include a set of bits designated for the predicate operand. The second circuitry 1002 can be configured to prevent the execution unit 312 from being configured to receive the content of the first subset 704 until after the result of the first instruction has been stored in the first subset 704. The second circuitry 1002 can be configured to prevent the fifth set 702 from being configured to receive the content of the second subset 706 until after the result of the first instruction has been stored in the second subset 706. For example, the at least one switch 1004 can include the first switch 1402 and the second switch 1404. For example, the first switch 1402 can be configured to prevent the execution unit 312 from being configured to receive the content of the first subset 704 until after the result of the first instruction has been stored in the first subset 704. For example, the second switch 1404 can be configured to prevent the fifth set 702 from being configured to receive the content of the second subset 706 until after the result of the first instruction has been stored in the second subset 706. In this manner, the first switch 1402 and the second switch 1404 can be operated independently of each other.

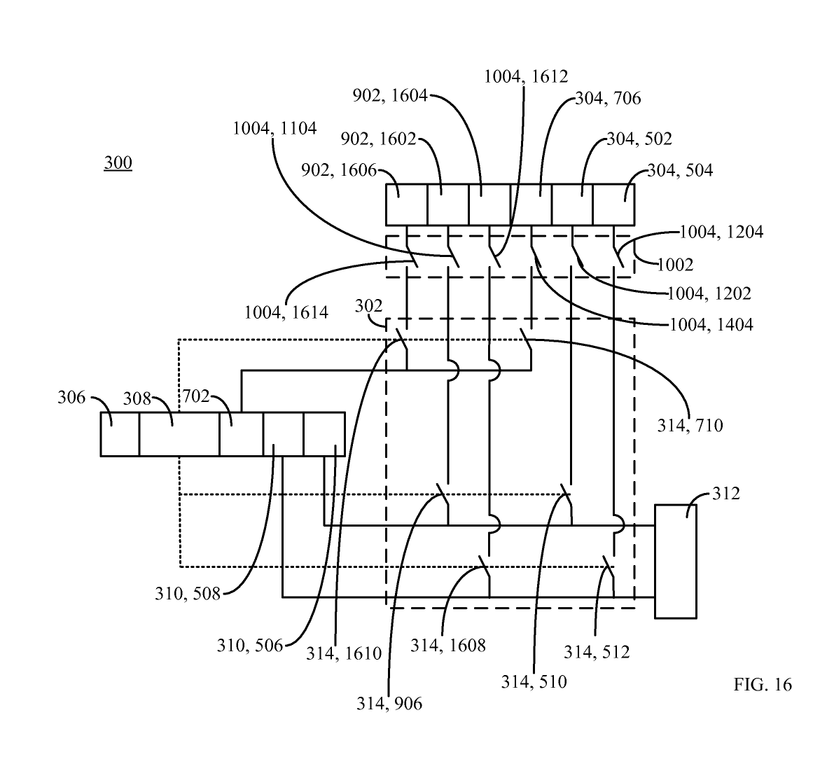

One of skill in the arts understands other aspects that can be realized through various combinations of the aspects described above with reference to FIGS. 3 through 15 such as is illustrated, for example, in FIG. 16. FIG. 16 is a block diagram illustrating another variation of the apparatus 300. In an aspect, the memory cells can further include the set 702 and the set 902. The set 902 can include a subset 1602, a subset 1604, and a subset 1606. The set 304 can include the subset 502, the subset 504, and the subset 706. The set 310 can include the subset 506 and the subset 508. The at least one switch 314 can include the switch 510, the switch 512, the switch 710, the switch 906, a switch 1608, and a switch 1610. The at least one switch 1004 can include, the switch 1202, the switch 1204, the switch 1404, the switch 1104, a switch 1612, and a switch 1614. The switch 906 can be configured so that the execution unit 312 can be configured to receive a content of the subset 1602. The switch 1608 can be configured so that the execution unit 312 can be configured to receive a content of the subset 1604. The switch 1610 can be configured so that the set 702 can be configured to receive a content of the subset 1606. The switch 1104 can be configured to prevent the execution unit 312 from being configured to receive the content of the subset 1602 until after the result of the first instruction (or another instruction) has been stored in the subset 1602. The switch 1612 can be configured to prevent the execution unit 312 from being configured to receive the content of the subset 1604 until after the result of the first instruction (or another instruction) has been stored in the subset 1604. The switch 1614 can be configured to prevent the set 702 from receiving the content of subset 1606 until after the result of the first instruction (or another instruction) has been stored in the subset 1606.

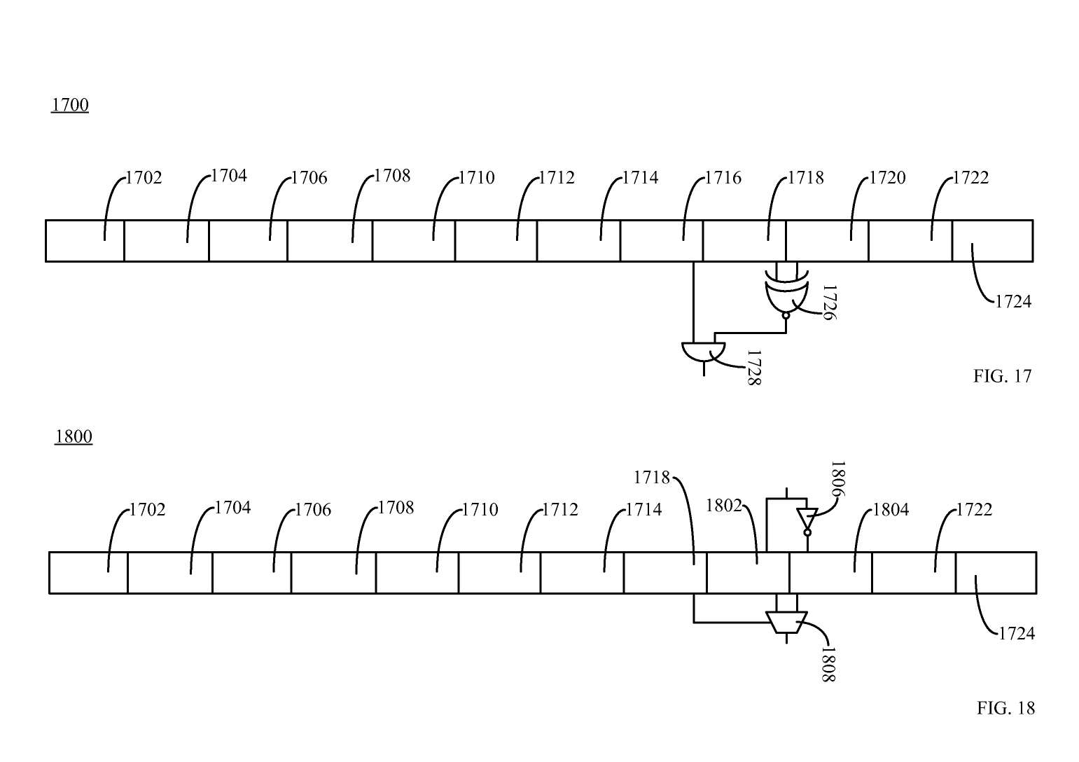

FIG. 17 is a diagram illustrating an example of a format 1700 of an instruction that can be executed by the apparatus 300. In an aspect, the format 1700 can include a set of bits 1702, a set of bits 1704, a set of bits 1706, a set of bits 1708, a set of bits 1710, a set of bits 1712, a set of bits 1714, a set of bits 1716, a set of bits 1718, a set of bits 1720, a set of bits 1722, and a set of bits 1724.

The set of bits 1702 can be designated for an operation code (i.e., an opcode). For example, the set of bits 1702 can be stored in the set 306. The set of bits 1704 can be designated for a first information of the instruction. For example, the set of bits 1704 can be stored in the set 308. For example, a presence of the first information in the set 308 can cause the first circuitry 302 to cause the execution unit 312 to be configured to receive the content of the set 304 or the set 902.

The set of bits 1706 can be designated for a second information of the instruction. For example, the set of bits 1706 can be stored in a set of memory cells. For example, a presence of the second information in this set of memory cells can be indicative that the instruction needs a first operand. The set of bits 1708 can be designated for a third information of the instruction. For example, the set of bits 1708 can be stored in a set of memory cells. For example, a presence of the third information in this set of memory cells can be indicative that the execution unit 312 has received the first operand. The set of bits 1710 can be designated for a fourth information of the instruction. For example, the set of bits 1710 can be stored in a set of memory cells. For example, a presence of the fourth information in this set of memory cells can be indicative that the instruction needs a second operand. The set of bits 1712 can be designated for a fifth information of the instruction. For example, the set of bits 1712 can be stored in a set of memory cells. For example, a presence of the fifth information in this set of memory cells can be indicative that the execution unit 312 has received the second operand.

The set of bits 1714 can be designated for a sixth information of the instruction. For example, the set of bits 1714 can be stored in a set of memory cells. For example, a presence of the sixth information in this set of memory cells can be indicative that the instruction needs a predicate operand. The set of bits 1716 can be designated for the predicate operand of the instruction. For example, the predicate operand can be stored in the set 702. For example, a presence of the predicate operand in the set 702 can be indicative that the predicate operand has been received by the instruction. The set of bits 1718 can be designated for a seventh information of the instruction. For example, the set of bits 1718 can be stored in a set of memory cells. For example, a presence of the seventh information in this set of memory cells can be indicative that the instruction needs the predicate operand to have a true value. The set of bits 1720 can be designated for an eighth information of the instruction. For example, the set of bits 1720 can be stored in a set of memory cells. For example, a presence of the eighth information in this set of memory cells can be indicative that the predicate operand, received by the instruction, has the true value.

For example, the set of bits 1718 can be a first input to an Exclusive NOR gate 1726 and the set of bits 1720 can be a second input to the Exclusive NOR gate 1726. If the presence of the seventh information in the set of bits 1718 indicates that the predicate operand needs to have the true value and the presence of the eighth information in the set of bits 1720 indicates that the predicate operand, received by the instruction, has the true value, then the output of the Exclusive NOR gate 1726 has the true value. If a lack of the presence of the seventh information in the set of bits 1718 indicates that the predicate operand needs to have a false value and a lack of the presence of the eighth information in the set of bits 1720 indicates that the predicate operand, received by the instruction, has the false value, then the output of the Exclusive NOR gate 1726 has the true value. For example, the set of bits 1716 can be a first input to an AND gate 1728, the output of the Exclusive NOR gate 1726 can be a second input to the AND gate 1728, and an output of the AND gate 1728 can enable the execution unit 312 to be configured to execute the instruction. A presence of the predicate operand in the set 702 indicates that the predicate operand has been received by the instruction and the output of the Exclusive NOR gate 1726 has the true value (indicative that the value of the predicate operand received by the instruction is the same as the value of the predicate operand needed by the instruction), then the output of the AND gate 1728 has the true value and can enable the execution unit 312 to be configured to execute the instruction.

The set of bits 1722 can be designated for an identity of a first destination of a result of the instruction. For example, the set of bits 1722 can be stored in a set of memory cells. The set of bits 1724 can be designated for an identity of a second destination of the result of the instruction. For example, the set of bits 1724 can be stored in a set of memory cells.

For example, the operation code in the set of bits 1702, the first information (to cause the first circuitry 302 to cause the execution unit 312 to be configured to receive the content of the set 304) in the set of bits 1704, the second information (indicative that the instruction needs the first operand) in the set of bits 1706, the fourth information (indicative that the instruction needs the second operand) in the set of bits 1710, the sixth information (indicative that the instruction needs the predicate operand) in the set of bits 1714, the seventh information (indicative that the instruction needs the predicate operand to have the true value) in the set of bits 1718, the identity of the first destination of the result of the instruction in the set of bits 1720, and the identity of the second destination of the result of the instruction in the set of bits 1722 can be included in the instruction at the time that the block of instructions is received by the instruction buffer 220 (see FIG. 2).

For example, the third information (indicative that the execution unit 312 has received the first operand) in the set of bits 1708, the fifth information (indicative that the execution unit 312 has received the second operand) in the set of bits 1712, the predicate operand in the set of bits 1716, the eighth information (indicative that the predicate operand, received by the instruction, has the true value) in the set of bits 1720 can be provided to the instruction as these items of information are produced in the course of executing the block of instructions.

For example, if there is a lack of presence of the second information (indicative that the instruction needs the first operand) in the set of bits 1706, which can be indicative that the instruction does not need the first operand, then the third information (indicative that the execution unit 312 has received the first operand) in the set of bits 1708 can be set to the true value by default so that execution of the instruction is not delayed in anticipation of receiving the first operand when the first operand is not needed. For example, if there is a lack of presence of the fourth information (indicative that the instruction needs the second operand) in the set of bits 1710, which can be indicative that the instruction does not need the second operand, then the fifth information (indicative that the execution unit 312 has received the second operand) in the set of bits 1712 can be set to the true value by default so that execution of the instruction is not delayed in anticipation of receiving the second operand when the second operand is not needed. For example, if there is a lack of presence of the sixth information (indicative that the instruction needs the predicate operand) in the set of bits 1714, which can be indicative that the instruction does not need the predicate operand, then all of the set of bits 1716 (indicative that the instruction has received the predicate operand), the seventh information (indicative that the instruction needs the predicate operand to have the true value) in the set of bits 1718, and the eighth information (indicative that the predicate operand, received by the instruction, has the true value) in the set of bits 1720 can be set to the true values by default so that execution of the instruction is not delayed in anticipation of receiving the predicate operand when the predicate operand is not needed.

FIG. 18 is a diagram illustrating an example of another format 1800 of an instruction that can be executed by the apparatus 300. In an aspect, the format 1800 can include the set of bits 1702, the set of bits 1704, the set of bits 1706, the set of bits 1708, the set of bits 1710, the set of bits 1712, the set of bits 1714, the set of bits 1718, the set of bits 1722, the set of bits 1724, a set of bits 1802, and a set of bits 1804. The set of bits 1802 can be designated for a ninth information. For example, the set of bits 1802 can be stored in a set of memory cells. For example, a presence of the ninth information in this set of memory cells can be indicative that the predicate operand has been received by the instruction and that the predicate operand has the true value. The set of bits 1804 can be designated for a tenth information. For example, the set of bits 1804 can be stored in a set of memory cells. For example, a presence of the tenth information in this set of memory cells can be indicative that the predicate operand has been received by the instruction and that the predicate operand has the false value.

For example, the predicate operand can be an input to the set of bits 1802 and an inverter 1806. An output of the inverter 1806 can be an input to the set of bits 1804. If the predicate operand has been received by the instruction and the predicate operand has the true value, then the set of bits 1802 can have the true value. If the predicate operand has been received by the instruction and the predicate operand has the false value, then the set of bits 1804 can have the true value. For example, the set of bits 1802 can be a first input to a multiplexer 1808, the set of bits 1804 can be a second input to the multiplexer 1808, the set of bits 1718 can be a selector input to the multiplexer 1808, and an output of the multiplexer 1808 can enable the execution unit 312 to be configured to execute the instruction. If the presence of the seventh information in the set of bits 1718 indicates that the predicate operand needs to have the true value, then the multiplexer 1808 can be configured to select the set of bits 1802 to enable the execution unit 312 to be configured to execute the instruction. If a lack of the presence of the seventh information in the set of bits 1718 indicates that the predicate operand needs to have the false value, then the multiplexer 1808 can be configured to select the set of bits 1804 to enable the execution unit 312 to be configured to execute the instruction.

Presented below is an example scenario to describe an operation of a system that includes the aspect of the apparatus 300 illustrated in FIG. 16. In the example scenario, a computer program to prepare a tax return can execute instructions I0 through I7. In an instruction I0, home mortgage interest paid by a married couple ($10,000) is loaded from a set of memory cells M1 in the at least one memory unit 126 (see FIG. 1) and is stored in the subset 506 for an instruction I2 as the first operand. In an instruction I1, real estate taxes paid by the couple ($4,000) is loaded from a set of memory cells M2 in the at least one memory unit 126 and is stored in the subset 508 for the instruction I2 as the second operand. In the instruction I2, itemized deductions (home mortgage interest paid added to real estate taxes paid) are calculated, are stored in the subset 506 for an instruction I4 as the first operand, and are stored in the subset 508 for an instruction I6 as the second operand. In an instruction I3, the value of a standard deduction ($12,200) is read from a register R0 in the physical register file 218 (see FIG. 2), is stored in the subset 508 for the instruction I4 as the second operand, and is stored in the subset 508 for an instruction I7 as the second operand. In the instruction I4, a predicate operand is set to true if the itemized deductions are greater than the standard deduction and is stored in the subset 706 for fan out as a predicate operand. In an instruction I5, income for the couple ($60,000) is loaded from a set of memory cells M0 in the at least one memory unit 126 and is stored in the subset 502 for fan out as a predicate operand. In the instruction I6, a first calculation for taxable income (itemized deductions subtracted from income) is performed if the predicate operand is a true value and a result of the first calculation is stored in a set of memory cells M3. In the instruction I7, a second calculation for taxable income (standard deduction subtracted from income) is performed if the predicate operand is a false value and a result of the second calculation is stored in the set of memory cells M3.

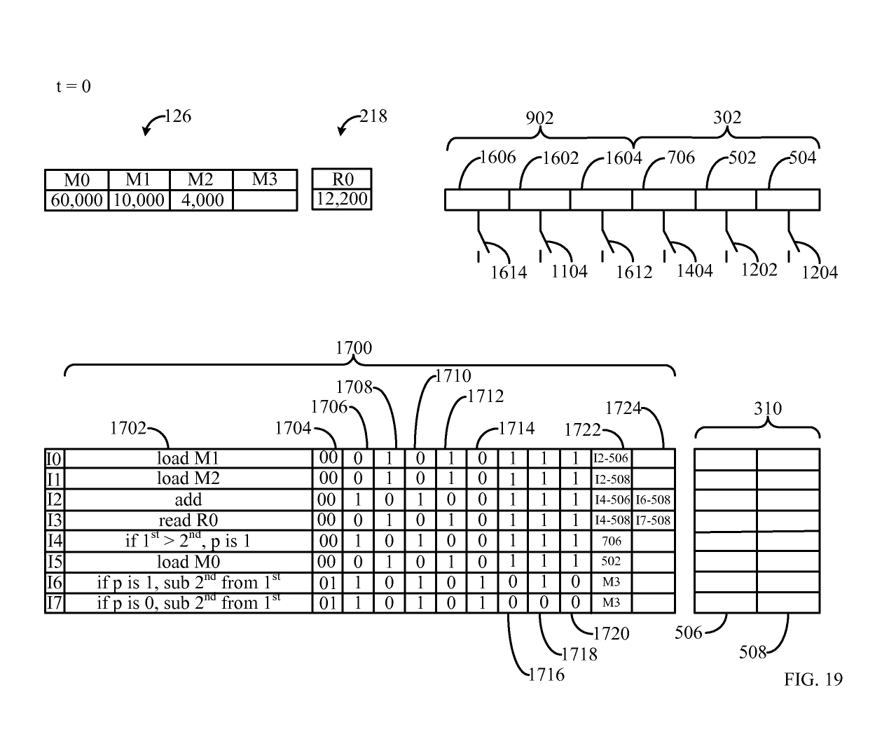

FIGS. 19 through 23 are diagrams that illustrate the states of some memory cells and switches associated with the example scenario to describe the operation of the system that includes the aspect of the apparatus 300 illustrated in FIG. 16. In the example scenario, the apparatus 300 executes instructions having the format 1700 illustrated in FIG. 17.

FIG. 19 illustrates the states of some memory cells and switches at a time t=0, the time that the block of instructions is received by the instruction buffer 220 (see FIG. 2).

At time t=0, each of the switches 1202, 1204, 1404, 1104, 1612, and 1614 is open. Because in each of the instructions I0, I1, I3, and I5 the set of bits 1706 (indicative that the instruction needs the first operand) is set to the false value (0), the set of bits 1708 (indicative that the corresponding execution unit 312 has received the first operand) is set to the true value (1) by default. Because in each of the instructions I0, I1, I3, and I5 the set of bits 1710 (indicative that the instruction needs the second operand) is set to the false value (0), the set of bits 1712 (indicative that the corresponding execution unit 312 has received the second operand) is set to the true value (1) by default. Because in each of the instructions I0, I1, I3, and I5 the set of bits 1714 (indicative that the instruction needs the predicate operand) is set to the false value (0), all of the set of bits 1716 (indicative that the instruction has received the predicate operand), the set of bits 1718 (indicative that the instruction needs the predicate operand to have the true value), and the set of bits 1720 (indicative that the predicate operand, received by the instruction, has the true value) are set to the true values (1) by default. Accordingly, in each of the instructions I0, I1, I3, and I5, the corresponding execution unit 312 has all of its operands as determined by the true value in each of the corresponding sets of bits 1708, 1712, and 1716 and by the value in the corresponding set of bits 1718 being equal to the value in the corresponding set of bits 1720. Therefore, the corresponding execution unit 312 can execute the instruction.

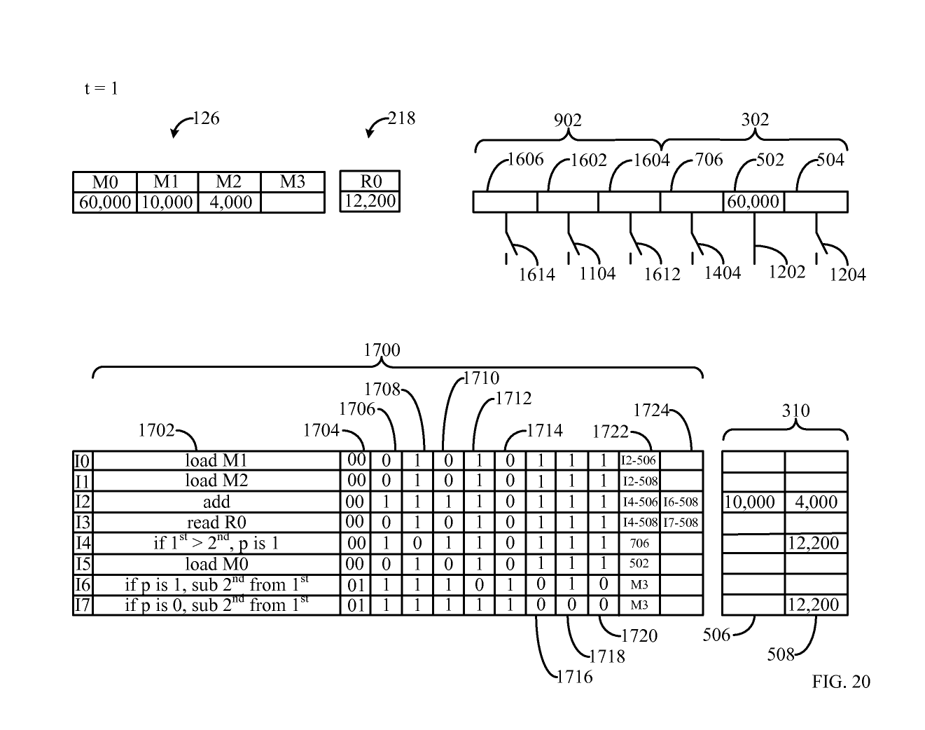

FIG. 20 illustrates the states of some memory cells and switches at a time t=1, after each of the instructions I0, I1, I3, and I5 has been executed.

After the instruction I0 has been executed, the value of the set of memory cells M1 (10,000) is stored, as indicated in the set of bits 1722 (designated for the identity of the first destination of the result of the instruction) of the instruction I0, in the subset 506 for the instruction I2 as the first operand. After the value of the set of memory cells M1 (10,000) has been stored as the first operand for the instruction I2, the true value (1) is stored in the set of bits 1708 (indicative that the corresponding execution unit 312 has received the first operand) of the instruction I2.

After the instruction I1 has been executed, the value of the set of memory cells M2 (4,000) is stored, as indicated in the set of bits 1722 (designated for the identity of the first destination of the result of the instruction) of the instruction I1, in the subset 508 for the instruction I2 as the second operand. After the value of the set of memory cells M2 (4,000) has been stored as the second operand for the instruction I2, the true value (1) is stored in the set of bits 1712 (indicative that the corresponding execution unit 312 has received the second operand) of the instruction I2.

Because in the instruction I2 the set of bits 1714 (indicative that the instruction needs the predicate operand) is set to the false value (0), all of the set of bits 1716 (indicative that the instruction has received the predicate operand), the set of bits 1718 (indicative that the instruction needs the predicate operand to have the true value), and the set of bits 1720 (indicative that the predicate operand, received by the instruction, has the true value) are set to the true values (1) by default. Accordingly, in the instruction I2, the corresponding execution unit 312 has all of its operands as determined by the true value in each of the corresponding sets of bits 1708, 1712, and 1716 and by the value in the corresponding set of bits 1718 being equal to the value in the corresponding set of bits 1720. Therefore, the corresponding execution unit 312 can execute the instruction.

After the instruction I3 has been executed, the value of the register R0 (12,200): (1) is stored, as indicated in the set of bits 1722 (designated for the identity of the first destination of the result of the instruction) of the instruction I3, in the subset 508 for the instruction I4 as the second operand and (2) is stored, as indicated in the set of bits 1724 (designated for the identity of the second destination of the result of the instruction) of the instruction I3, in the subset 508 for the instruction I7 as the second operand. After the value of the register R0 (12,200) has been stored as the second operand for the instruction I4, the true value (1) is stored in the set of bits 1712 (indicative that the corresponding execution unit 312 has received the second operand) of the instruction I4. After the value of the register R0 (12,200) has been stored as the second operand for the instruction I7, the true value (1) is stored in the set of bits 1712 (indicative that the corresponding execution unit 312 has received the second operand) of the instruction I7.

After the instruction I5 has been executed, the value of the set of memory cells M0 (60,000) is stored, as indicated in the set of bits 1722 (designated for the identity of the first destination of the result of the instruction) of the instruction I5, in the subset 502 of the set 304 for fan out as a first operand. After the value of the set of memory cells M0 (60,000) has been stored in the subset 502 of the set 304, the switch 1202 is closed.

Because in the instruction I6 the first information in the set of bits 1704 (to cause the first circuitry 302 to cause the corresponding execution unit 312 to be configured to receive the content of the set 304 or the set 902) has the value 01, the corresponding execution unit 312 is configured to receive the content of the set 304, which is the content of the subset 502, which is configured for fan out as a first operand. Accordingly, the true value (1) is stored in the set of bits 1708 (indicative that the corresponding execution unit 312 has received the first operand) of the instruction I6.

Because in the instruction I7 the first information in the set of bits 1704 (to cause the first circuitry 302 to cause the corresponding execution unit 312 to be configured to receive the content of the set 304 or the set 902) has the value 01, the corresponding execution unit 312 is configured to receive the content of the set 304, which is the content of the subset 502, which is configured for fan out as a first operand. Accordingly, the true value (1) is stored in the set of bits 1708 (indicative that the corresponding execution unit 312 has received the first operand) of the instruction I7.

Alternatively, for the instruction I6, the instruction I7, or both, rather than having the true value (1) stored in the set of bits 1708 in response to the first information in the set of bits 1704 having the value 01, a set of bits (not illustrated) can be designated for information about the content of the set 304. For example, this set of bits can be stored in a set of memory cells. For example, a presence of the information in this set of memory cells can be indicative that the set 304 has received the content. For example, this set of bits can be a first input to an OR gate (not illustrated), the set of bits 1708 can be a second input to the OR gate, and the output of the OR gate can be indicative that the corresponding execution unit 312 has received the first operand of the instruction. In an aspect, another set of bits (not illustrated) can be designated for information about the content of the set 902. For example, this set of bits can be stored in a set of memory cells. For example, a presence of the information in this set of memory cells can be indicative that the set 902 has received the content. For example, this set of bits can be a third input to the OR gate. For example, other circuitry (not illustrated) can indicate an error if the content of the set 304 and the content of the set 902 are both configured to be received as an operand by the corresponding execution unit 312.

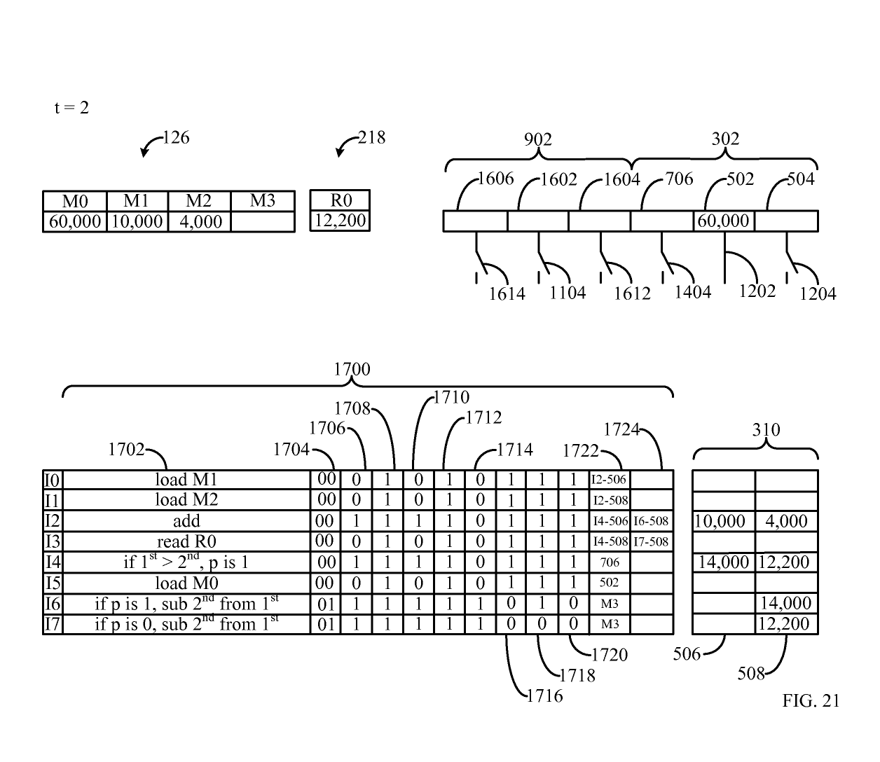

FIG. 21 illustrates the states of some memory cells and switches at a time t=2, after the instruction I2 has been executed.

After the instruction I2 has been executed, the value of the sum (14,000) of the first operand (10,000) added to the second operand (4,000): (1) is stored, as indicated in the set of bits 1722 (designated for the identity of the first destination of the result of the instruction) of the instruction I2, in the subset 506 for the instruction I4 as the first operand and (2) is stored, as indicated in the set of bits 1724 (designated for the identity of the second destination of the result of the instruction) of the instruction I2, in the subset 508 for the instruction I6 as the second operand. After the value of the sum (14,000) has been stored as the first operand for the instruction I4, the true value (1) is stored in the set of bits 1708 (indicative that the corresponding execution unit 312 has received the first operand) of the instruction I4. After the value of the sum (14,000) has been stored as the second operand for the instruction I6, the true value (1) is stored in the set of bits 1712 (indicative that the corresponding execution unit 312 has received the second operand) of the instruction I6.

Because in the instruction I4 the set of bits 1714 (indicative that the instruction needs the predicate operand) is set to the false value (0), all of the set of bits 1716 (indicative that the instruction has received the predicate operand), the set of bits 1718 (indicative that the instruction needs the predicate operand to have the true value), and the set of bits 1720 (indicative that the predicate operand, received by the instruction, has the true value) are set to the true values (1) by default. Accordingly, in the instruction I4, the corresponding execution unit 312 has all of its operands as determined by the true value in each of the corresponding sets of bits 1708, 1712, and 1716 and by the value in the corresponding set of bits 1718 being equal to the value in the corresponding set of bits 1720. Therefore, the corresponding execution unit 312 can execute the instruction.

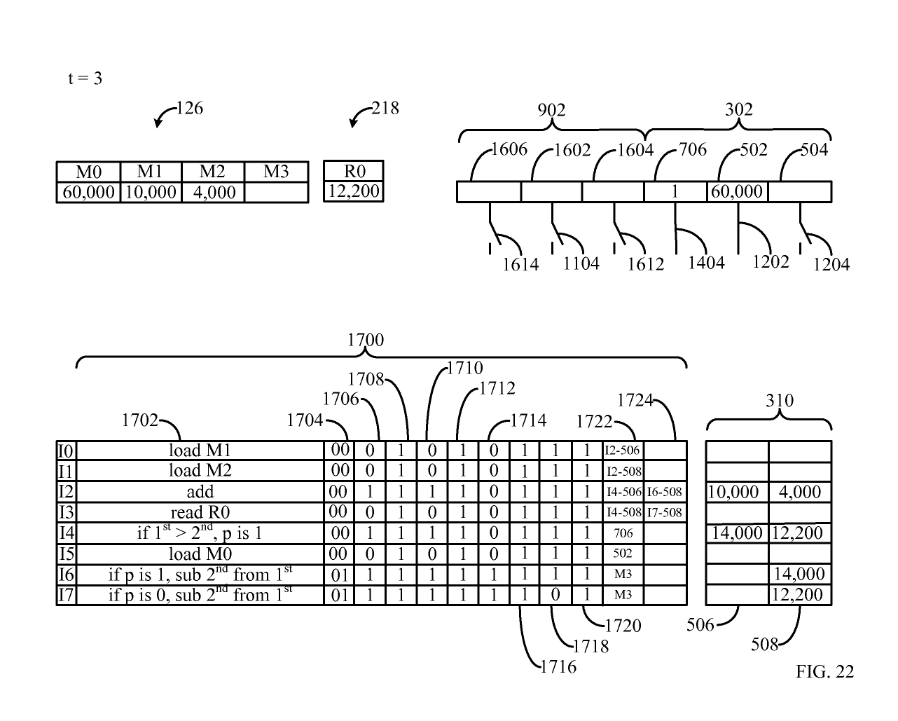

FIG. 22 illustrates the states of some memory cells and switches at a time t=3, after the instruction I4 has been executed.

After the instruction I4 has been executed, the value of the predicate operand is set to the true value (1) because the value of the first operand (14,000) is greater than the value of the second operand (12,200). The value of the predicate operand (1) is stored, as indicated in the set of bits 1722 (designated for the identity of the first destination of the result of the instruction) of the instruction I4, in the subset 706 of the set 304 for fan out as a predicate operand. After the value of the predicate operand (1) has been stored in the subset 706 of the set 304, the switch 1404 is closed.

Because in the instruction I6 the first information in the set of bits 1704 (to cause the first circuitry 302 to cause the corresponding execution unit 312 to be configured to receive the content of the set 304 or the set 902) has the value 01, the corresponding execution unit 312 is configured to receive the content of the set 304, which is the content of the subset 502 and the content of the subset 706, which are configured for fan out, respectively, as a first operand and as a predicate operand. Accordingly, the true value (1) is stored in the set of bits 1716 (indicative that the corresponding execution unit 312 has received the predicate operand) of the instruction I6.

Alternatively, rather than having the true value (1) stored in the set of bits 1716 in response to the first information in the set of bits 1704 having the value 01, a set of bits (not illustrated) can be designated for information about the content of the set 304. For example, this set of bits can be stored in a set of memory cells. For example, a presence of the information in this set of memory cells can be indicative that the set 304 has received the content. For example, this set of bits can be a first input to an OR gate (not illustrated), the set of bits 1716 can be a second input to the OR gate, and the output of the OR gate can be indicative that the corresponding execution unit 312 has received the first operand of the instruction. In an aspect, another set of bits (not illustrated) can be designated for information about the content of the set 902. For example, this set of bits can be stored in a set of memory cells. For example, a presence of the information in this set of memory cells can be indicative that the set 902 has received the content. For example, this set of bits can be a third input to the OR gate. For example, other circuitry (not illustrated) can indicate an error if the content of the set 304 and the content of the set 902 are both configured to be received as an operand by the corresponding execution unit 312.

Because the predicate operand (stored in subset 706) has the true value (1), the true value (1) is stored in the set of bits 1720 (indicative that the predicate operand, received by the instruction, has the true value) of the instruction I6. Accordingly, in the instruction I6, the corresponding execution unit 312 has all of its operands as determined by the true value in each of the corresponding sets of bits 1708, 1712, and 1716 and by the value in the corresponding set of bits 1718 being equal to the value in the corresponding set of bits 1720. Therefore, the corresponding execution unit 312 can execute the instruction.

Because in the instruction I7 the first information in the set of bits 1704 (to cause the first circuitry 302 to cause the corresponding execution unit 312 to be configured to receive the content of the set 304 or the set 902) has the value 01, the corresponding execution unit 312 is configured to receive the content of the set 304, which is the content of the subset 502 and the content of the subset 706, which are configured for fan out, respectively, as a first operand and as a predicate operand. Accordingly, the true value (1) is stored in the set of bits 1716 (indicative that the corresponding execution unit 312 has received the predicate operand) of the instruction I7.

Alternatively, rather than having the true value (1) stored in the set of bits 1716 in response to the first information in the set of bits 1704 having the value 01, a set of bits (not illustrated) can be designated for information about the content of the set 304. For example, this set of bits can be stored in a set of memory cells. For example, a presence of the information in this set of memory cells can be indicative that the set 304 has received the content. For example, this set of bits can be a first input to an OR gate (not illustrated), the set of bits 1716 can be a second input to the OR gate, and the output of the OR gate can be indicative that the corresponding execution unit 312 has received the first operand of the instruction. In an aspect, another set of bits (not illustrated) can be designated for information about the content of the set 902. For example, this set of bits can be stored in a set of memory cells. For example, a presence of the information in this set of memory cells can be indicative that the set 902 has received the content. For example, this set of bits can be a third input to the OR gate. For example, other circuitry (not illustrated) can indicate an error if the content of the set 304 and the content of the set 902 are both configured to be received as an operand by the corresponding execution unit 312.

Because the predicate operand (stored in subset 706) has the true value (1), the true value (1) is stored in the set of bits 1720 (indicative that the predicate operand, received by the instruction, has the true value) of the instruction I7. Accordingly, in the instruction I7, the corresponding execution unit 312 does not have all of its operands as determined by the value in the corresponding set of bits 1718 not being equal to the value in the corresponding set of bits 1720 even though each of the corresponding sets of bits 1708, 1712, and 1716 has the corresponding true value. Therefore, the corresponding execution unit 312 cannot execute the instruction.

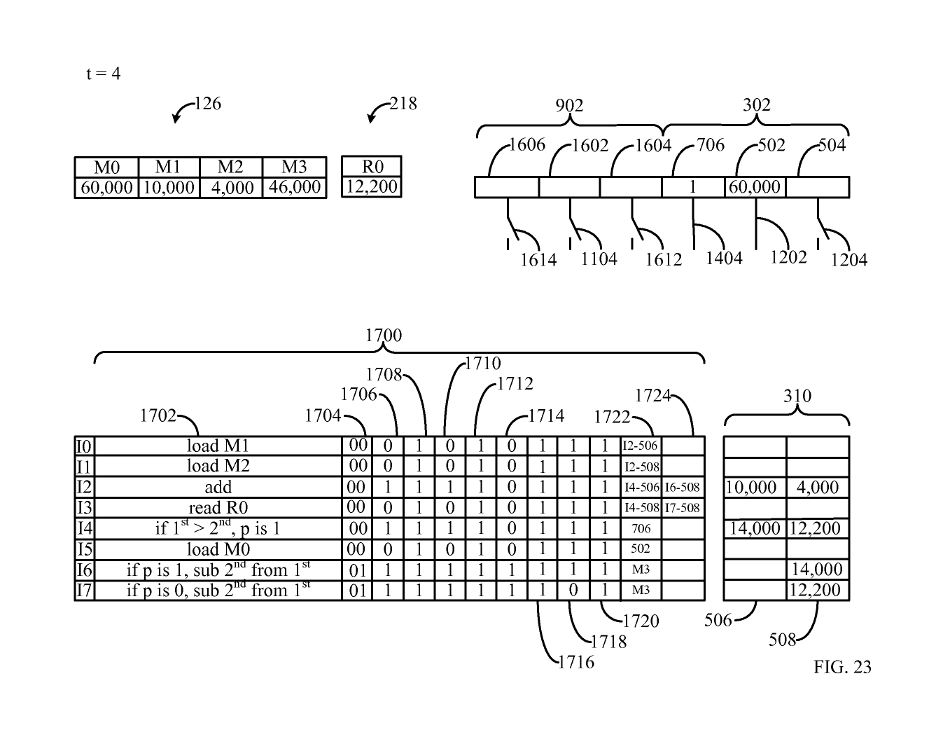

FIG. 23 illustrates the states of some memory cells and switches at a time t=4, after the instruction I6 has been executed.

After the instruction I6 has been executed, the value of the difference (46,000) of the second operand (14,000) subtracted from the first operand (60,000) is stored, as indicated in the set of bits 1722 (designated for the identity of the first destination of the result of the instruction) of the instruction I6, in the set of memory cells M3.

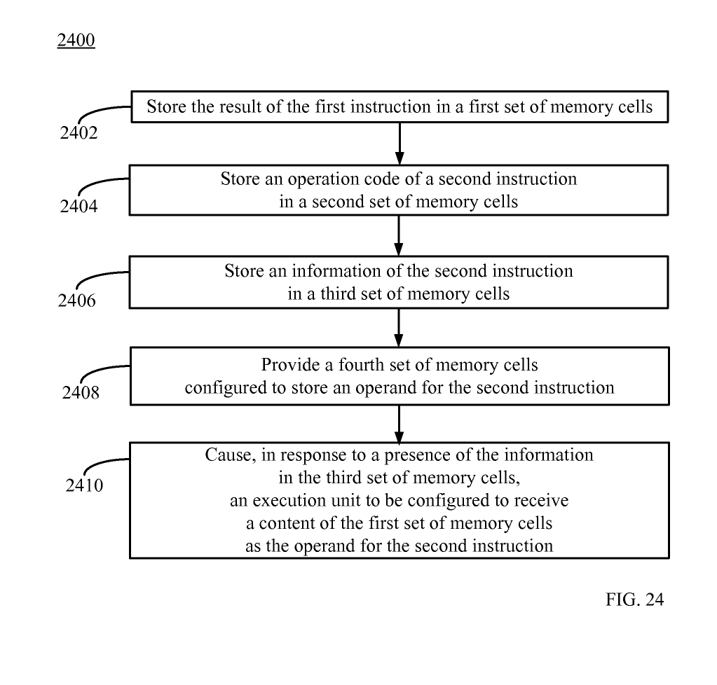

FIG. 24 is a flow diagram illustrating an example of a method 2400 for fan out of a result of an instruction. In the method 2400, at an operation 2402, the result of the first instruction can be stored in a first set of memory cells. At an operation 2404, an operation code (i.e., opcode) of a second instruction can be stored in a second set of memory cells. At an operation 2406, an information of the second instruction can be stored in a third set of memory cells. A format of the second instruction can include a set of bits designated for the operation code and a set of bits designated for the information. At an operation 2408, a fourth set of memory cells, configured to store an operand for the second instruction, can be provided. The first set of memory cells, the second set of memory cells, the third set of memory cells, and the fourth set of memory cells can be disjoint. At an operation 2410, an execution unit can be caused, in response to a presence of the information in the third set of memory cells, to be configured to receive a content of the first set of memory cells as the operand for the second instruction.

Those of skill in the art appreciate that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

While the foregoing description provides illustrative aspects, it is noted that various changes and modifications can be made to these illustrative aspects without departing from the scope defined by the appended claims.

What is claimed is:

1. An apparatus for fan out of a result of a first instruction, the apparatus comprising:
memory cells including:
a first set configured to store the result of the first instruction;
a second set configured to store an operation code of a second instruction;
a third set configured to store an information of the second instruction; and
a fourth set configured to store an operand for the second instruction; and
a first circuitry configured to connect the fourth set to an execution unit and configured to cause, in response to a presence of the information in the third set, the execution unit to be configured to receive a content of the first set as the operand for the second instruction;
wherein the first set, the second set, the third set, and the fourth set are disjoint; and
wherein a format of the second instruction includes a set of bits designated for the operation code and a set of bits designated for the information.

2. The apparatus of claim 1, wherein:
each memory cell of the second set comprises a random access memory cell; and
each memory cell of the third set comprises a flip-flop.

3. The apparatus of claim 1, wherein the first circuitry comprises at least one switch.

4. The apparatus of claim 3, wherein the at least one switch comprises at least one of a relay, a microelectromechanical switch, a semiconductor device, a transistor, a multiplexer, a pass gate, or any combination thereof.

5. The apparatus of claim 1, wherein:
a record of a reservation station of an array of reservation stations includes the second set, the third set, and the fourth set; and
the array of reservation stations excludes the first set.

6. The apparatus of claim 1, wherein the first set includes a first subset and a second subset, the fourth set includes a third subset and a fourth subset, the third subset configured to store a first operand for the second instruction, the fourth subset configured to store a second operand for the second instruction, and the first circuitry is configured to cause, in response to the presence of the information in the third set, the execution unit to be configured to receive a content of the first subset as the first operand for the second instruction and a content of the second subset as the second operand for the second instruction.

7. The apparatus of claim 1, wherein the first set includes a first subset and a second subset, the third set includes a third subset and a fourth subset, the fourth set includes a fifth subset and a sixth subset, the third subset configured to store a first information of the second instruction, the fourth subset configured to store a second information of the second instruction, the fifth subset configured to store a first operand for the second instruction, the sixth subset configured to store a second operand for the second instruction, and the first circuitry is configured to cause:
in response to a presence of the first information in the third subset, the execution unit to be configured to receive a content of the first subset as the first operand for the second instruction; and
in response to a presence of the second information in the fourth subset, the execution unit to be configured to receive a content of the second subset as the second operand for the second instruction.

8. The apparatus of claim 1, wherein the memory cells further comprise a fifth set configured to store a predicate operand of the second instruction, the format of the second instruction further includes a set of bits designated for the predicate operand, the first set includes a first subset and a second subset, and the first circuitry is configured to cause, in response to the presence of the information in the third set:
the execution unit to be configured to receive a content of the first subset as the operand for the second instruction; and
the fifth set to be configured to receive a content of the second subset as the predicate operand of the second instruction.

9. The apparatus of claim 1, wherein the memory cells further comprise a fifth set configured to store a predicate operand of the second instruction, the format of the second instruction further includes a set of bits designated for the predicate operand, the first set includes a first subset and a second subset, the third set includes a third subset and a fourth subset, the third subset configured to store a first information of the second instruction, the fourth subset configured to store a second information of the second instruction, and the first circuitry is configured to cause:
in response to a presence of the first information in the third subset, the execution unit to be configured to receive a content of the first subset as the operand for the second instruction; and
in response to a presence of the second information in the fourth subset, the fifth set to be configured to receive a content of the second subset as the predicate operand of the second instruction.

10. The apparatus of claim 1, wherein the memory cells further comprise a fifth set configured to store the result of the first instruction, the information is configured to have one of a first value or a second value, and the first circuitry is configured to cause:
in response to the presence of the information having the first value in the third set, the execution unit to be configured to receive the content of the first set as the operand for the second instruction; and
in response to the presence of the information having the second value in the third set, the execution unit to be configured to receive a content of the fifth set as the operand for the second instruction.

11. The apparatus of claim 1, further comprising a second circuitry configured to prevent the execution unit from being configured to receive the content of the first set until after the result of the first instruction has been stored in the first set.

12. The apparatus of claim 11, wherein the memory cells further comprise a fifth set configured to store the result of the first instruction, and the second circuitry is further configured to prevent the execution unit from being configured to receive a content of the fifth set until after the result of the first instruction has been stored in the fifth set.

13. The apparatus of claim 1, wherein the first set includes a first subset and a second subset, and further comprising a second circuitry configured to prevent the execution unit from being configured to receive the content of the first set until after the result of the first instruction has been stored in at least one of the first subset or the second subset.

14. The apparatus of claim 1, wherein the first set includes a first subset and a second subset, and further comprising a second circuitry configured to prevent the execution unit from being configured to receive:
a content of the first subset until after the result of the first instruction has been stored in the first subset; and
a content of the second subset until after the result of the first instruction has been stored in the second subset.

15. The apparatus of claim 1, wherein the first set includes a first subset and a second subset, the memory cells further comprise a fifth set configured to store a predicate operand of the second instruction, the format of the second instruction further includes a set of bits designated for the predicate operand, and further comprising a second circuitry configured to prevent the execution unit and the fifth set from being configured to receive the content of the first set until after the result of the first instruction has been stored in at least one of the first subset or the second subset.

16. The apparatus of claim 1, wherein the first set includes a first subset and a second subset, the memory cells further comprise a fifth set configured to store a predicate operand of the second instruction, the format of the second instruction further includes a set of bits designated for the predicate operand, and further comprising a second circuitry configured to prevent:
the execution unit from being configured to receive a content of the first subset until after the result of the first instruction has been stored in the first subset; and
the fifth set from being configured to receive a content of the second subset until after the result of the first instruction has been stored in the second subset.

17. An apparatus for fan out of a result of a first instruction, the apparatus comprising:
means for storing the result of the first instruction;
means for storing an operation code of a second instruction;
means for storing an information of the second instruction;
means for storing an operand for the second instruction; and
means for causing, in response to a presence of the information in the means for storing the information, means for executing the second instruction to be configured to receive a content of the means for storing the result as the operand for the second instruction;
wherein the means for storing the results, the means for storing the operation code, the means for storing the information, and the means for storing the operand are disjoint; and
wherein a format of the second instruction includes a set of bits designated for the operation code and a set of bits designated for the information.

18. The apparatus of claim 17, further comprising means for preventing the means for executing the second instruction from being configured to receive the content of the means for storing the result until after the result of the first instruction has been stored in the means for storing the result.

19. A method for fan out of a result of a first instruction, the method comprising:
storing the result of the first instruction in a first set of memory cells;
storing an operation code of a second instruction in a second set of memory cells;
storing an information of the second instruction in a third set of memory cells;
providing a fourth set of memory cells configured to store an operand for the second instruction; and
causing, in response to a presence of the information in the third set of memory cells, an execution unit to be configured to receive a content of the first set of memory cells as the operand for the second instruction;
wherein the first set of memory cells, the second set of memory cells, the third set of memory cells, and the fourth set of memory cells are disjoint; and
wherein a format of the second instruction includes a set of bits designated for the operation code and a set of bits designated for the information.

20. A computer processor core, comprising:
an array having a reservation station, the reservation station having a first record, the first record having a first set of memory cells and a second set of memory cells, the first set of memory cells configured to store an operation code of a first instruction, the second set of memory cells configured to store a first information of the first instruction, the second set of memory cells and the first set of memory cells being disjoint, a format of the first instruction including a set of bits designated for the operation code and a set of bits designated for the first information, the first instruction being of a block of instructions, the block of instructions configured according to a block-based instruction set architecture; and
a circuitry configured to make a determination of a presence of the first information in the second set of memory cells, to select, in response to the determination, a source of an operand for the first instruction, and to execute the block of instructions as a unit.

21. The computer processor core of claim 20, wherein the first record further includes a third set of memory cells configured to store an identity of a destination of a result of the first instruction, and wherein the format of the first instruction further includes a set of bits designated for the identity of the destination of the result of the first instruction.

22. The computer processor core of claim 21, wherein the array has a second record, the second record having a fourth set of memory cells, the fourth set of memory cells configured to store an operand for a second instruction, and wherein the circuitry is further configured so that the fourth set of memory cells is a first candidate for the destination of the result of the first instruction.

23. The computer processor core of claim 22, further comprising a fifth set of memory cells configured to store the result of the first instruction, wherein the array excludes the fifth set of memory cells, wherein the fifth set of memory cells is different from a register of a physical register file of the computer processor core, wherein the circuitry is further configured so that the fifth set of memory cells is a second candidate for the destination of the result of the first instruction, and wherein the circuitry is further configured so that data stored in the fifth set of memory cells are accessible by any execution unit that corresponds to the array without a requirement that the data traverse a cache between the fifth set of memory cells and the any execution unit.

24. The computer processor core of claim 20, wherein the first record further includes a third set of memory cells configured to store an operand for the first instruction and further comprising a fourth set of memory cells, wherein the array excludes the fourth set of memory cells, wherein the fourth set of memory cells is different from a register of a physical register file of the computer processor core, wherein the circuitry is further configured so that data stored in the fourth set of memory cells are accessible by any execution unit that corresponds to the array without a requirement that the data traverse a cache between the fourth set of memory cells and the any execution unit, and wherein the circuitry is configured to select, in response to the presence of the first information in the second set of memory cells, a content of the fourth set of memory cells as the source of the operand for the first instruction.

25. The computer processor core of claim 24, further comprising a fifth set of memory cells, wherein the array excludes the fifth set of memory cells, wherein the fifth set of memory cells is different from the register, wherein the circuitry is further configured so that data stored in the fifth set of memory cells are accessible by the any execution unit without the requirement that the data traverse the cache between the fifth set of memory cells and the any execution unit, wherein the first information includes at least one of a first information or a second first information, and wherein the circuitry is configured to select:
in response to a presence of the first information in the second set of memory cells, the content of the fourth set of memory cells as the source of the operand for the first instruction; and
in response to a presence of the second first information in the second set of memory cells, the content of the fifth set of memory cells as the source of the operand for the first instruction.

26. The computer processor core of claim 20, wherein the first record further includes a third set of memory cells configured to store a predicate operand of the first instruction, and wherein the format of the first instruction further includes a set of bits designated for the predicate operand.

27. The computer processor core of claim 26, further comprising a fourth set of memory cells, wherein the array excludes the fourth set of memory cells, wherein the fourth set of memory cells is different from a register of a physical register file of the computer processor core, wherein the circuitry is further configured so that data stored in the fourth set of memory cells are accessible by any execution unit that corresponds to the array without a requirement that the data traverse a cache between the fourth set of memory cells and the any execution unit, and wherein the circuitry is configured to select, in response to the presence of the information in the second set of memory cells, a content of the fourth set of memory cells as the source of the predicate operand of the first instruction.

28. The computer processor core of claim 20, wherein the first record further includes:
a third set of memory cells configured to store a second information, wherein the format of the first instruction further includes a set of bits designated for the second information, a presence of the second information in the third set of memory cells indicative that the first instruction needs a predicate operand;
a fourth set of memory cells configured to store a third information, wherein the format of the first instruction further includes a set of bits designated for the third information, a presence of the third information in the fourth set of memory cells indicative that the predicate operand needs to have a true value;
a fifth set of memory cells configured to store a fourth information, wherein a presence of the fourth information in the fifth set of memory cells is indicative that the predicate operand has been received by the first instruction; and
a sixth set of memory cells configured to store a fifth information, wherein a presence of the fifth information in the sixth set of memory cells is indicative that the predicate operand, received by the first instruction, has the true value.

29. The computer processor core of claim 20, wherein the first record further includes:
a third set of memory cells configured to store a second information, wherein the format of the first instruction further includes a set of bits designated for the second information, a presence of the second information in the third set of memory cells indicative that the first instruction needs a predicate operand;
a fourth set of memory cells configured to store a third information, wherein the format of the first instruction further includes a set of bits designated for the third information, a presence of the third information in the fourth set of memory cells indicative that the predicate operand needs to have a true value;
a fifth set of memory cells configured to store a fourth information, wherein a presence of the fourth information in the fifth set of memory cells is indicative that the predicate operand has been received by the first instruction and the predicate operand has the true value; and
a sixth set of memory cells configured to store a fifth information, wherein a presence of the fifth information in the sixth set of memory cells is indicative that the predicate operand has been received by the first instruction and the predicate operand has a false value.

30. The computer processor core of claim 20, wherein the first record further includes:
a third set of memory cells configured to store a first operand for the first instruction;
a fourth set of memory cells configured to store a second information, wherein the format of the first instruction further includes a set of bits designated for the second information, a presence of the second information in the fourth set of memory cells indicative that the first instruction needs the first operand;
a fifth set of memory cells configured to store a third information, wherein a presence of the third information in the fifth set of memory cells is indicative that an execution unit that corresponds to the first record has received the first operand;
a sixth set of memory cells configured to store a second operand for the first instruction;
a seventh set of memory cells configured to store a fourth information, wherein the format of the first instruction further includes a set of bits designated for the fourth information, a presence of the fourth information in the seventh set of memory cells indicative that the first instruction needs the second operand; and
an eighth set of memory cells configured to store a fifth information, wherein a presence of the fifth information in the eighth set of memory cells is indicative that the execution unit has received the second operand.
